(19) United States
(12) Patent Application Publication
(10) Pub. No.: US 2024/0297536 A1
(43) Pub. Date: Sep. 5, 2024

(54) WIRELESS POWER TRANSMISSION DEVICE AND WIRELESS POWER SYSTEM COMPRISING SAME

(71) Applicant: LG ELECTRONICS INC., Seoul (KR)

(72) Inventors: Hyoungseok KIM, Seoul (KR); Jonggu KIM, Seoul (KR); Seonghun LEE, Seoul (KR); Jaeyeol KIM, Seoul (KR)

(73) Assignee: LG ELECTRONICS INC., Seoul (KR)

(21) Appl. No.: 18/280,895

(22) PCT Filed: Mar. 9, 2021
(86) PCT No.: PCT/KR2021/002905

§ 371 Date: Sep. 7, 2023

(51) Int. Cl. H02J 50/90; H02J 50/12; H02J 50/40; H02J 50/80

(52) U.S. Cl. CPC H02J 50/90; H02J 50/12; H02J 50/402; H02J 50/80

(57) ABSTRACT

The present invention relates to a wireless power transmission device and a wireless power system comprising same. The wireless power transmission device and wireless power system comprising same, according to one embodiment of the present invention, comprise: a coil assembly including a plurality of coils; a first resonant capacitor connected to a first group of the plurality of coils; and a second resonant capacitor connected to a second group of the plurality of coils, and connected in parallel to the first resonant capacitor, wherein the number of groups of the plurality of coils is smaller than the number of the plurality of coils. Accordingly, a circuit for the selection and operation of at least some of the plurality of coils can be simply implemented, and charging can be quickly entered.

### BACKGROUND

### 1. Field

The present disclosure relates to a wireless power transfer apparatus and a wireless power system including the same, and more particularly to a wireless power transfer apparatus capable of simply implementing a circuit for selecting and operating at least some of a plurality of coils and capable of rapidly entering a charging state, and a wireless power system including the wireless power transfer apparatus.

### 2. Description of the Related Art

Methods of supplying power to electronic devices are divided into a wired power transfer method, a wireless power transfer method, and the like.

In the wired power transfer method, cables or wires occupy a considerable amount of space, and arrangement thereof is not easy, leading to a risk of disconnection. For this reason, the wireless power transfer method has drawn attention recently.

The wireless power transfer method may be divided into a single-coil method using a single transmission coil, a multi-coil method using multiple transmission coils, and the like.

Regarding the multi-coil method, Korean Laid-open Patent Publication No. 10-2017-0054708 (hereinafter referred to as a “prior art”) relates to a multi-coil wireless charging method and an apparatus and system therefor, and discloses a wireless charging method using multiple coils.

However, the prior art has a drawback in that in order to select multiple coils, coils are selected by sequentially driving the respective coils, and then receiving signal strength information from a wireless power reception apparatus, such that it takes a considerable period of time to select the coils.

Further, the prior art also has a drawback in that a circuit for driving coils is complicated, and the number of circuit elements increases, thereby increasing the volume of the wireless power transfer apparatus.

### SUMMARY

It is an object of the present disclosure to provide a wireless power transfer apparatus capable of simply implementing a circuit for selecting and operating at least some of a plurality of coils and capable of rapidly entering a charging state, and a wireless power system including the same.

Meanwhile, it is another object of the present disclosure to provide a wireless power transfer apparatus capable of reducing a coil selection period for selecting at least some of a plurality of coils, and a wireless power system including the same.

In accordance with an aspect of the present disclosure, the above and other objects can be accomplished by the provision of a wireless power transfer apparatus and a wireless power system including the same including: a coil assembly including a plurality of coils; a first resonant capacitor connected to a first group among the plurality of coils; and a second resonant capacitor connected to a second group among the plurality of coils, and connected in parallel to the first resonance capacitor, wherein a number of the groups of the plurality of coils are less thnn a number of the plurality of coils.

Meanwhile, a first coil among the plurality of coils and a coil not adjacent to the first coil may be included in the first group, and a second coil adjacent to the first coil and a coil not adjacent to the second coil may be included in the second group.

Meanwhile, the wireless power transfer apparatus and the wireless power system including the same may further include coil switching devices respectively connected to the plurality of coils, wherein based on simultaneous turning on of coil switching devices of some of the plurality of coils in the first group and coil switching devices of some of the plurality of coils in the second group, a first current may flow to the first resonant capacitor, and a second current may flow to the second resonant capacitor.

Meanwhile, the wireless power transfer apparatus and the wireless power system including the same may further include: an inverter configured to perform a switching operation to supply power to at least one of the plurality of coils; and a controller configured to control the inverter, wherein the controller may be configured to: during a first period, receive first signal strength information and second signal strength information from a wireless power reception apparatus in response to operation of some coils in the first group and some coils in the second group among the plurality of coils; during a second period following the first period, receive third signal strength information from the wireless power reception apparatus in response to operation of other coils in the first group and other coils in the second group among the plurality of coils; and based on the first to third pieces of signal strength information, select at least one coil from among the plurality of coils and operate the selected coil.

Meanwhile, the wireless power transfer apparatus and the wireless power system including the same may further include: coil switching devices respectively connected to the plurality of coils; an inverter configured to perform a switching operation to supply power to at least one of the plurality of coils; and a controller configured to control the inverter, wherein the controller may be configured to: during a first period, receive first signal strength information and second signal strength information from a wireless power reception apparatus in response to turning on coil switching devices of some coils in the first group and coil switching devices of some coils in the second group among the plurality of coils; during a second period following the first period, receive third signal strength information from the wireless power reception apparatus in response to turning on coil switching devices of other coils in the first group and coil switching devices of other coils in the second group among the plurality of coils; and based on the first to third pieces of signal strength information, select at least one coil from among the plurality of coils and operate the selected coil.

Meanwhile, the wireless power transfer apparatus and the wireless power system including the same may further include: a first decoding line connected to the first resonant capacitor; a second decoding line connected to the second resonant capacitor; an inverter configured to perform a switching operation to supply power to at least one of the plurality of coils; and a controller configured to control the inverter, wherein the controller may be configured to: receive first signal strength information and second signal strength information from the wireless power reception apparatus through the first decoding line and the second decoding line, respectively; and based on the first to third pieces of signal strength information, select at least one coil from among the plurality of coils and operate the selected coil.

Meanwhile, the controller may be configured to: during a first period, receive first signal strength information and second signal strength information from the wireless power reception apparatus through the first decoding line and the second decoding line, in response to operation of some coils in the first group and some coils in the second group among the plurality of coils; during a second period following the first period, receive third signal strength information and fourth signal strength information from the wireless power reception apparatus through the first decoding line and the second decoding line, in response to operation of other coils in the first group and other coils in the second group among the plurality of coils; and based on the first to fourth pieces of signal strength information, select at least one coil from among the plurality of coils and operate the selected coil.

Meanwhile, the inverter may include a first switching device and a second switching device which are connected in series to each other, and a third switching device and a fourth switching device which are connected in series to each other and are connected in parallel to the first switching device and the second switching device, wherein an operating voltage source may be connected to one end of the first switching device and one end of the third switching device, a ground terminal may be connected to one end of the second switching device and one end of the fourth switching device, and a current detector may be connected to another end of the second switching device or another end of the fourth switching device.

Meanwhile, a first coil among the plurality of coils and a second coil adjacent to the first coil in a first direction may be included in the first group, and a third coil adjacent to the first coil in a second direction and a fourth coil adjacent to the third coil in the first direction may be included in the second group.

Meanwhile, in response to the plurality of coils being arranged in the first direction, the first coil and the third coil may be included in the first group among the first to fourth coils, and the second coil and the fourth coils may be included in the second group among the plurality of coils.

Meanwhile, the wireless power transfer apparatus and the wireless power system including the same may further include: a third resonant capacitor connected to a third group among the plurality of coils; a switching inverter configured to perform a switching operation to supply power to at least one of the plurality of coils; and a controller configured to control the inverter, wherein the controller may be configured to: during a first period, receive signal strength information from the wireless power reception apparatus in response to operation of some coils in the first group, some coils in the second group, and some coils in the third group among the plurality of coils; and based on the signal strength information received during the first period, select at least one coil from among the plurality of coils and operate the selected coil.

Meanwhile, the controller may be configured to: during a second period following the first period, receive signal strength information from the wireless power reception apparatus in response to operation of other coils in the first group and other coils in the second group; and based on the signal strength information received during the first period and the second period, select at least one coil from among the plurality of coils and operate the selected coil.

Meanwhile, the wireless power transfer apparatus and the wireless power system including the same may further include: coil switching devices respectively connected to the plurality of coils; an inverter configured to perform a switching operation to supply power to at least one of the plurality of coils; and a controller configured to control the inverter, wherein the controller may be configured to: in response to wireless power transfer at a level less than or equal to a first reference value being required, drive only one coil selected from among the first group and the second group; and in response to wireless power transfer at a level greater than the first reference value being required, drive two coils selected from among the first group and the second group and greater in number than the one coil.

Meanwhile, the wireless power transfer apparatus and the wireless power system including the same may further include: coil switching devices respectively connected to the plurality of coils; an inverter configured to perform a switching operation to supply power to at least one of the plurality of coils; and a controller configured to control the inverter, wherein the controller may be configured to: in response to the wireless power transfer apparatus being spaced apart from the wireless power reception apparatus by a first distance, drive only one coil selected from among the first group and the second group; and in response to the wireless power transfer apparatus being spaced apart from the wireless power reception apparatus by a second distance which is larger than the first distance, drive two coils selected from among the first group and the second group and greater in number than the one coil.

Meanwhile, the wireless power transfer apparatus and the wireless power system including the same may further include: coil switching devices respectively connected to the plurality of coils; an inverter configured to perform a switching operation to supply power to at least one of the plurality of coils; and a controller configured to control the inverter, wherein the controller may be configured to: in response to movement of the wireless power reception apparatus while at least some coils in the first group are driven, operate the at least some coils in the first group and at least some coils in the second group.

In accordance with another aspect of the present disclosure, a wireless power transfer apparatus and a wireless power system including the same include: a coil assembly including a plurality of coils; a first resonant capacitor connected to a first group among the plurality of coils; a second resonant capacitor connected to a second group among the plurality of coils, an inverter configured to perform a switching operation to supply power to at least one of the plurality of coils; and a controller configured to control the inverter, wherein the controller may be configured to sequentially drive some coils in the first group and some coils in the second group, and to select at least one coil based on signal strength information, received from a wireless power reception apparatus while sequentially driving the coils, and operate the selected at least one coil.

Meanwhile, the controller may be configured to: during a first period, receive signal strength information from the wireless power reception apparatus in response to operation of some coils in the first group and some coils in the second group; during a second period following the first period, receive signal strength information from the wireless power reception apparatus in response to operation of other coils in the first group and other coils in the second group; and operate at least one coil selected based on the signal strength information received during the first period and the second period.

Meanwhile, the wireless power transfer apparatus and the wireless power system including the same may further include: a first decoding line connected to the first resonant capacitor; and a second decoding line connected to the second resonant capacitor; wherein the controller may be configured to: receive first signal strength information and second signal strength information from the wireless power reception apparatus through the first decoding line and the second decoding line, respectively; and based on the first signal strength information or the second signal strength information, select at least one coil from among the plurality of coils and operate the selected at least one coil.

In accordance with yet another aspect of the present disclosure, a wireless power transfer apparatus and a wireless power system including the same include: a coil assembly including a plurality of coils; in response to the plurality of coils being divided into a plurality of groups, a plurality of resonant capacitors connected corresponding to the plurality of groups; an inverter configured to perform a switching operation to supply power to at least one of the plurality of coils; and a controller configured to control the inverter, wherein the controller may be configured to: based on signal strength information received from the wireless power reception apparatus for each of the plurality of groups, operate at least some coils among the plurality of coils; and in response to movement of the wireless power reception apparatus, change a group to be driven.

Meanwhile, the controller may be configured to: in response to wireless power transfer at a level less than or equal to a first reference value being required, drive only one coil selected from among the first group and the second group; and in response to wireless power transfer at a level greater than the first reference value being required, drive two coils selected from among the first group and the second group and greater in number than the one coil.

### EFFECTS OF THE DISCLOSURE

A wireless power transfer apparatus and a wireless power system including the same according to an embodiment of the present disclosure include: a coil assembly including a plurality of coils; a first resonant capacitor connected to a first group among the plurality of coils; and a second resonant capacitor connected to a second group among the plurality of coils, and connected in parallel to the first resonance capacitor, wherein a number of the groups of the plurality of coils are less thnn a number of the plurality of coils. Accordingly, the wireless power transfer apparatus and the wireless power system including the same may simply implement a circuit for selecting and operating at least some of the plurality of coils, and may rapidly enter a charging state. Particularly, by using only the resonant capacitors corresponding to the number of groups, the wireless power transfer apparatus may be reduced in size while simply implementing the circuit. In addition, a plurality of wireless power reception apparatuses may be charged wirelessly by driving the plurality of coils.

Meanwhile, a first coil among the plurality of coils and a coil not adjacent to the first coil may be included in the first group, and a second coil adjacent to the first coil and a coil not adjacent to the second coil may be included in the second group. Accordingly, by grouping the coils not adjacent to each other, a wider area may be covered during wireless power transfer.

Meanwhile, the wireless power transfer apparatus and the wireless power system including the same may further include coil switching devices respectively connected to the plurality of coils, wherein based on simultaneous turning on of coil switching devices of some of the plurality of coils in the first group and coil switching devices of some of the plurality of coils in the second group, a first current may flow to the first resonant capacitor, and a second current may flow to the second resonant capacitor. Accordingly, the wireless power transfer apparatus and the wireless power system including the same may simply implement a circuit for selecting and operating at least some of the plurality of coils, and may rapidly enter a charging state. Particularly, the coils may be simply driven by group.

Meanwhile, the wireless power transfer apparatus and the wireless power system including the same may further include: an inverter configured to perform a switching operation to supply power to at least one of the plurality of coils; and a controller configured to control the inverter, wherein the controller may be configured to: during a first period, receive first signal strength information and second signal strength information from a wireless power reception apparatus in response to operation of some coils in the first group and some coils in the second group among the plurality of coils; during a second period following the first period, receive third signal strength information from the wireless power reception apparatus in response to operation of other coils in the first group and other coils in the second group among the plurality of coils; and based on the first to third pieces of signal strength information, select at least one coil from among the plurality of coils and operate the selected coil. Accordingly, a coil selection period may be significantly reduced by selectively driving the coils by group, compared to the case of selecting coils by individually driving the plurality of coils.

Meanwhile, the wireless power transfer apparatus and the wireless power system including the same may further include: coil switching devices respectively connected to the plurality of coils; an inverter configured to perform a switching operation to supply power to at least one of the plurality of coils; and a controller configured to control the inverter, wherein the controller may be configured to: during a first period, receive first signal strength information and second signal strength information from a wireless power reception apparatus in response to turning on coil switching devices of some coils in the first group and coil switching devices of some coils in the second group among the plurality of coils; during a second period following the first period, receive third signal strength information from the wireless power reception apparatus in response to turning on coil switching devices of other coils in the first group and coil switching devices of other coils in the second group among the plurality of coils; and based on the first to third pieces of signal strength information, select at least one coil from among the plurality of coils and operate the selected coil. Accordingly, at least one coil may be simply selected.

Meanwhile, the wireless power transfer apparatus and the wireless power system including the same may further include: a first decoding line connected to the first resonant capacitor; a second decoding line connected to the second resonant capacitor; an inverter configured to perform a switching operation to supply power to at least one of the plurality of coils; and a controller configured to control the inverter, wherein the controller may be configured to: receive first signal strength information and second signal strength information from the wireless power reception apparatus through the first decoding line and the second decoding line, respectively; and based on the first to third pieces of signal strength information, select at least one coil from among the plurality of coils and operate the selected coil. Accordingly, a coil selection period may be significantly reduced by selectively driving the coils by group, compared to the case of selecting coils by individually driving the plurality of coils.

Meanwhile, the controller may be configured to: during a first period, receive first signal strength information and second signal strength information from the wireless power reception apparatus through the first decoding line and the second decoding line, in response to operation of some coils in the first group and some coils in the second group among the plurality of coils; during a second period following the first period, receive third signal strength information and fourth signal strength information from the wireless power reception apparatus through the first decoding line and the second decoding line, in response to operation of other coils in the first group and other coils in the second group among the plurality of coils; and based on the first to fourth pieces of signal strength information, select at least one coil from among the plurality of coils and operate the selected coil. Accordingly, a coil selection period may be significantly reduced by selectively driving the coils by group, compared to the case of selecting coils by individually driving the plurality of coils.

Meanwhile, the inverter may include a first switching device and a second switching device which are connected in series to each other, and a third switching device and a fourth switching device which are connected in series to each other and are connected in parallel to the first switching device and the second switching device, wherein an operating voltage source may be connected to one end of the first switching device and one end of the third switching device, a ground terminal may be connected to one end of the second switching device and one end of the fourth switching device, and a current detector may be connected to another end of the second switching device or another end of the fourth switching device. Accordingly, based on the current flowing through the inverter, at least one coil may be selected from among the plurality of coils.

Meanwhile, a first coil among the plurality of coils and a second coil adjacent to the first coil in a first direction may be included in the first group, and a third coil adjacent to the first coil in a second direction and a fourth coil adjacent to the third coil in the first direction may be included in the second group. Accordingly, the coils may be grouped in various shapes, and by the grouping, the wireless power transfer apparatus and the wireless power system including the same may simply implement a circuit for selecting and operating at least some of the plurality of coils and may rapidly enter a charging state.

Meanwhile, in response to the plurality of coils being arranged in the first direction, the first coil and the third coil may be included in the first group among the first to fourth coils, and the second coil and the fourth coils may be included in the second group among the plurality of coils. Accordingly, the coils may be grouped in various shapes, and by the grouping, the wireless power transfer apparatus and the wireless power system including the same may simply implement a circuit for selecting and operating at least some of the plurality of coils and may rapidly enter a charging state.

Meanwhile, the wireless power transfer apparatus and the wireless power system including the same may further include: a third resonant capacitor connected to a third group among the plurality of coils; a switching inverter configured to perform a switching operation to supply power to at least one of the plurality of coils; and a controller configured to control the inverter, wherein the controller may be configured to: during a first period, receive signal strength information from the wireless power reception apparatus in response to operation of some coils in the first group, some coils in the second group, and some coils in the third group among the plurality of coils; and based on the signal strength information received during the first period, select at least one coil from among the plurality of coils and operate the selected coil. Accordingly, a coil selection period may be significantly reduced by selectively driving the coils by group, compared to the case of selecting coils by individually driving the plurality of coils.

Meanwhile, the controller may be configured to: during a second period following the first period, receive signal strength information from the wireless power reception apparatus in response to operation of other coils in the first group and other coils in the second group; and based on the signal strength information received during the first period and the second period, select at least one coil from among the plurality of coils and operate the selected coil. Accordingly, a coil selection period may be significantly reduced by selectively driving the coils by group, compared to the case of selecting coils by individually driving the plurality of coils.

Meanwhile, the wireless power transfer apparatus and the wireless power system including the same may further include: coil switching devices respectively connected to the plurality of coils; an inverter configured to perform a switching operation to supply power to at least one of the plurality of coils; and a controller configured to control the inverter, wherein the controller may be configured to: in response to wireless power transfer at a level less than or equal to a first reference value being required, drive only one coil selected from among the first group and the second group; and in response to wireless power transfer at a level greater than the first reference value being required, drive two coils selected from among the first group and the second group and greater in number than the one coil. Accordingly, the number of operating coils may change depending on power required for wireless power transfer.

Meanwhile, the wireless power transfer apparatus and the wireless power system including the same may further include: coil switching devices respectively connected to the plurality of coils; an inverter configured to perform a switching operation to supply power to at least one of the plurality of coils; and a controller configured to control the inverter, wherein the controller may be configured to: in response to the wireless power transfer apparatus being spaced apart from the wireless power reception apparatus by a first distance, drive only one coil selected from among the first group and the second group; and in response to the wireless power transfer apparatus being spaced apart from the wireless power reception apparatus by a second distance which is larger than the first distance, drive two coils selected from among the first group and the second group and greater in number than the one coil. Accordingly, the number of operating coils may change depending on power required for wireless power transfer.

Meanwhile, the wireless power transfer apparatus and the wireless power system including the same may further include: coil switching devices respectively connected to the plurality of coils; an inverter configured to perform a switching operation to supply power to at least one of the plurality of coils; and a controller configured to control the inverter, wherein the controller may be configured to: in response to movement of the wireless power reception apparatus while at least some coils in the first group are driven, operate the at least some coils in the first group and at least some coils in the second group. Accordingly, the number of operating coils may change depending on power required for wireless power transfer.

A wireless power transfer apparatus and a wireless power system including the same according to another embodiment of the present disclosure include: a coil assembly including a plurality of coils; a first resonant capacitor connected to a first group among the plurality of coils; a second resonant capacitor connected to a second group among the plurality of coils, an inverter configured to perform a switching operation to supply power to at least one of the plurality of coils; and a controller configured to control the inverter, wherein the controller may be configured to sequentially drive some coils in the first group and some coils in the second group, and to select at least one coil based on signal strength information, received from a wireless power reception apparatus while sequentially driving the coils, and operate the selected at least one coil. Accordingly, the wireless power transfer apparatus and the wireless power system including the same may simply implement a circuit for selecting and operating at least some of the plurality of coils, and may rapidly enter a charging state. Particularly, by using only the resonant capacitors corresponding to the number of groups, the wireless power transfer apparatus may be reduced in size while simply implementing the circuit. In addition, a plurality of wireless power reception apparatuses may be charged wirelessly by driving the plurality of coils.

Meanwhile, the controller may be configured to: during a first period, receive signal strength information from the wireless power reception apparatus in response to operation of some coils in the first group and some coils in the second group; during a second period following the first period, receive signal strength information from the wireless power reception apparatus in response to operation of other coils in the first group and other coils in the second group; and operate at least one coil selected based on the signal strength information received during the first period and the second period. Accordingly, a coil selection period may be significantly reduced by selectively driving the coils by group, compared to the case of selecting coils by individually driving the plurality of coils.

Meanwhile, the wireless power transfer apparatus and the wireless power system including the same may further include: a first decoding line connected to the first resonant capacitor; and a second decoding line connected to the second resonant capacitor; wherein the controller may be configured to: receive first signal strength information and second signal strength information from the wireless power reception apparatus through the first decoding line and the second decoding line, respectively; and based on the first signal strength information or the second signal strength information, select at least one coil from among the plurality of coils and operate the selected at least one coil. Accordingly, a coil selection period may be significantly reduced by selectively driving the coils by group, compared to the case of selecting coils by individually driving the plurality of coils.

A wireless power transfer apparatus and a wireless power system including the same according to yet another embodiment of the present disclosure include: a coil assembly including a plurality of coils; in response to the plurality of coils being divided into a plurality of groups, a plurality of resonant capacitors connected corresponding to the plurality of groups; an inverter configured to perform a switching operation to supply power to at least one of the plurality of coils; and a controller configured to control the inverter, wherein the controller may be configured to: based on signal strength information received from the wireless power reception apparatus for each of the plurality of groups, operate at least some coils among the plurality of coils; and in response to movement of the wireless power reception apparatus, change a group to be driven. Accordingly, the wireless power transfer apparatus and the wireless power system including the same may simply implement a circuit for selecting and operating at least some of the plurality of coils, and may rapidly enter a charging state. In addition, a group to be driven changes in response to movement of the wireless power reception apparatus or in response to an increase in the number of wireless power reception apparatuses, such that adaptive wireless charging may be provided.

Meanwhile, the controller may be configured to: in response to wireless power transfer at a level less than or equal to a first reference value being required, drive only one coil selected from among the first group and the second group; and in response to wireless power transfer at a level greater than the first reference value being required, drive two coils selected from among the first group and the second group and greater in number than the one coil. Accordingly, the number of operating coils may change depending on power required for wireless power transfer.

### BRIEF DESCRIPTION OF THE DRAWINGS

The embodiments will be described in detail with reference to the following drawings in which like reference numerals refer to like elements wherein:

FIG. 1 is a block diagram illustrating a wireless power system according to an embodiment of the present disclosure;

FIG. 2 is an internal block diagram of a wireless power transfer apparatus of FIG. 1;

FIG. 3 is an internal block diagram of a wireless power reception apparatus of FIG. 1;

FIG. 4 is a diagram illustrating an example of a plurality of coils included in a wireless power transfer apparatus;

FIG. 5 is a diagram illustrating a hierarchical structure of the plurality of coils of FIG. 4;

FIG. 6A is a diagram illustrating an example of a coil assembly associated with the present disclosure;

FIG. 6B is a diagram illustrating an example of a wireless power driver corresponding to the coil assembly of FIG. 6A;

FIG. 7A is a diagram illustrating an example of a coil assembly associated with the present disclosure;

FIG. 7B is a diagram illustrating another example of a wireless power driver corresponding to the coil assembly of FIG. 7A;

FIG. 8A is a flowchart illustrating an example of a wireless power transfer method of a wireless power transfer apparatus associated with the present disclosure;

FIG. 8B is a flowchart illustrating an example of an operation method of the wireless power driver of FIG. 7B;

FIGS. 9A and 9B are diagrams referred to in the description of FIG. 8B;

FIG. 10A is a diagram illustrating an example of a coil assembly according to an embodiment of the present disclosure;

FIG. 10B is a bottom view of the coil assembly of FIG. 10A;

FIG. 10C is a diagram illustrating an example of a wireless power transfer apparatus including a wireless power driver corresponding to the coil assembly of FIG. 10A;

FIG. 11 is a flowchart illustrating an example of an operation method of the wireless power driver of FIG. 10C;

FIGS. 12A to 14B are diagrams referred to in the description of operation of FIG. 11;

FIG. 15A is a diagram illustrating an example of a coil assembly according to another embodiment of the present disclosure;

FIG. 15B is a diagram illustrating an example of a wireless power transfer apparatus including a wireless power driver corresponding to the coil assembly of FIG. 15A;

FIGS. 16A to 17 are diagrams referred to in the description of FIGS. 15A and 15B;

FIGS. 18A to 18G are diagrams illustrating examples of a coil array of various shapes or groups; and

FIG. 19 is a circuit diagram illustrating an example of a wireless power transfer apparatus including a wireless power driver corresponding to FIG. 18A.

### DETAILED DESCRIPTION

Reference will now be made in detail to the embodiments of the present disclosure, examples of which are illustrated in the accompanying drawings. To clearly and briefly describe the present disclosure, a part without concerning to the description is omitted in the drawings, and the same or like reference numerals in the specification denote the same elements.

The suffixes “module” and “unit” of elements herein are used for convenience of description and thus can be used interchangeably and do not have any distinguishable meanings or functions. Thus, the “module” and the “unit” may be interchangeably used.

Throughout this specification, the terms such as “include” or “comprise” may be construed to denote a certain characteristic, number, step, operation, constituent element, or a combination thereof, but may not be construed to exclude the existence of or a possibility of addition of one or more other characteristics, numbers, steps, operations, constituent elements, or combinations thereof.

It will be understood that, although the terms “first”, “second”, “third” etc. may be used herein to describe various elements, these elements should not be limited by these terms. These terms are only used to distinguish one element from another element.

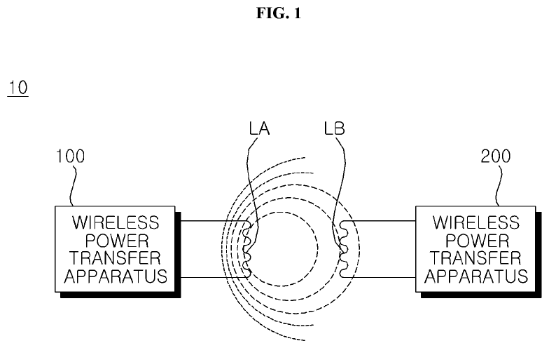

FIG. 1 is a block diagram illustrating a wireless power system according to an embodiment of the present disclosure.

Referring to FIG. 1, the wireless power system 10 may include a wireless power transfer apparatus 100 for wirelessly transferring power and a wireless power reception apparatus 200 for receiving the transferred power.

The wireless power transfer apparatus 100 may wirelessly transfer power to the wireless power reception apparatus 200 using a self-induction phenomenon whereby current is induced in a reception coil LB included in the wireless power reception apparatus 200 along with a change of a magnetic field due to current flowing in a first coil LA.

In this case, the wireless power transfer apparatus 100 and the wireless power reception apparatus 200 may use a wireless charging method in an electromagnetic induction manner defined in the wireless power consortium (WPC) or power matters alliance (PMA).

For example, the wireless power transfer apparatus 100 and the wireless power reception apparatus 200 may use a wireless charging method in a magnetic resonance manner defined in an alliance for wireless power (A4WP).

One wireless power transfer apparatus 100 may transfer power to the plurality of wireless power reception apparatuses 200.

In this case, the wireless power transfer apparatus 100 may transfer power to the plurality of wireless power reception apparatuses 200 using a time division method, but the present disclosure is not limited thereto, and power may also be transferred to the plurality of wireless power reception apparatuses 200 using different frequency bands that are respectively allocated to the plurality of wireless power reception apparatuses 200.

The number of the wireless power reception apparatuses 200 for receiving power from one wireless power transfer apparatus 100 may be adaptively determined in consideration of required electric energy of each of the plurality of wireless power reception apparatuses 200, available electric energy of the wireless power transfer apparatus 100, or the like.

In another example, a plurality of wireless power transfer apparatuses 100 may transfer power to at least one wireless power reception apparatus 200.

In this case, the at least one wireless power reception apparatus 200 may be simultaneously connected to the plurality of wireless power transfer apparatuses 100 and may simultaneously receive power from the connected wireless power transfer apparatus 100.

The number of the wireless power transfer apparatuses 100 may be adaptively determined in consideration of required electric energy of each of the at least one wireless power reception apparatus 200, available electric energy of the wireless power transfer apparatus 100, or the like.

The wireless power reception apparatus 200 may receive power transferred from the wireless power transfer apparatus 100.

For example, the wireless power reception apparatus 200 may be an electronic device having small power (power less than or equal to about 5 W or about 20 W), such as a mobile phone, a wearable device such as a smart watch, personal digital assistants (PDA), a portable multimedia player (PMP), a navigation device, an MP3 player, an electric toothbrush, earphones, or a remote controller, or an electronic device having medium power (power less than or equal to about 50 W or about 200 W), such as a laptop computer, a robot cleaner, TV, audio equipment, a cleaner, a monitor, a robot, a drone, etc., or an electronic device having high power (power less than or equal to about 2 kW or about 22 kW), such as kitchen appliances including a mixer, a microwave oven, and an electric rice cooker, a wheelchair, an electric scooter, an electric bicycle, an electric car, and the like.

The wireless power transfer apparatus 100 and the wireless power reception apparatus 200 may communicate with each other. In some embodiments, the wireless power transfer apparatus 100 and the wireless power reception apparatus 200 may perform one-way communication or two-way communication.

In this case, the communication method may be an in-band communication method using the same frequency band and/or out-of-band communication method using different frequency bands.

Data that is transmitted and received between the wireless power transfer apparatus 100 and the wireless power reception apparatus 200 may include data about the state of a device, data about the amount of electricity used, data about battery charge, data about an output voltage and/or output current of a battery, data related to a control command, or the like.

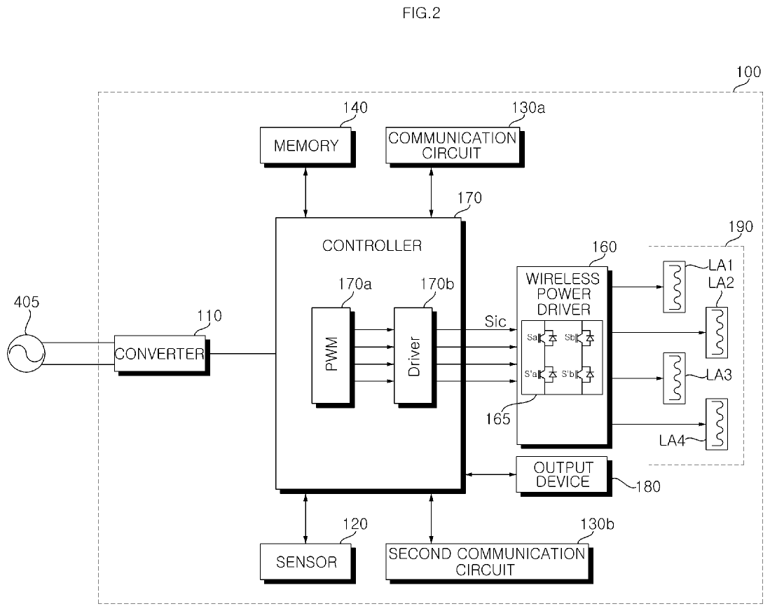

FIG. 2 is an internal block diagram of a wireless power transfer apparatus of FIG. 1.

Referring to FIG. 2, the wireless power transfer apparatus 100 may include a controller 170 for controlling each of components included in the wireless power transfer apparatus 100, a wireless power driver 160 for converting direct current (DC) power into alternating current (AC) power, and a coil assembly 190 including a plurality of coils for wirelessly transmitting power using the converted AC power.

The wireless power transfer apparatus 100 may further include a converter 110 for converting commercial AC power 405 into DC power, a memory 140 for storing control programs for driving the wireless power transfer apparatus 100, a sensor 120 for detecting current and/or voltage input to the components included in the coil assembly 190, and/or first and second communication circuits 130a and 130b that communicate with the wireless power reception apparatus 200 using a predetermined communication method.

The converter 110 may rectify input AC power into DC power and may output the rectified DC power. In this case, the AC power may be single phase AC power or three phase AC power. Each of the components included in the wireless power transfer apparatus 100 may be operated by DC power output from the converter 110.

Although the commercial AC power 405 is illustrated as single phase AC power in the drawings, the present disclosure is not limited thereto, and the commercial AC power 405 may also be three phase AC power. The internal configuration of the converter 110 may also be changed depending on a type of the commercial AC power 405.

The converter 110 may include a bridge diode. An upper arm diode device and a lower arm diode device that are connected in series to each other may be configured in a pair, and total of two pairs or three pairs of upper and lower arm diode devices may be connected in parallel to each other. The converter 110 may further include a plurality of switching devices.

The memory 140 may store various data for an overall operation of the wireless power transfer apparatus 100 a program for processing or controlling the controller 170.

For example, the memory 140 may store data about output intensity of an object detection signal for determining presence of an object positioned in a charge region.

Here, the charge region may refer to one region of an external surface of a housing of the wireless power transfer apparatus 100, which corresponds to a plurality of coils LA1 to LA4, and the wireless power reception apparatus 200 may contact the charge region or may be positioned within a predetermined distance from the charge region to receive power.

For example, the memory 140 may identify whether an object positioned in the charge region is the wireless power reception apparatus 200 and may store data about output intensity of a reception apparatus detection signal for awaking the wireless power reception apparatus 200.

The data about output intensity of the object detection signal and/or the data about output intensity of the reception apparatus detection signal, which are stored in the memory 140 may include a factory-calibrated data value.

For example, when at least some of the plurality of coils LA1 to LA4 overlap each other to form layers, intensities of signals output from the plurality of coils LA1 to LA4 to the charge region may be different for the respective plurality of coils LA1 to LA4, and an error may occur due to the difference of signal intensities during determination of whether an object is detected.

Accordingly, it is preferred that the intensities or strengths of signals output from the plurality of coils LA1 to LA4 may be compensated and set for respective coils in consideration of a distance between the plurality of coils LA1 to LA4 and the charge region.

For example, as a distance between the charge region and a coil increases, a signal with higher output intensity may be set to be output.

Meanwhile, the memory 140 may store data about a reference value related to a variation of current flowing in the coil assembly 190 according to output of the object detection signal. Here, the reference value may refer to a range of predetermined value.

For example, the memory 140 may store data about a reference value related to a quality factor Q of the plurality of coils LA1 to LA4.

For example, the memory 140 may store data about a reference value related to signal intensity or strength of a response signal to a reception apparatus detection signal, which is received in response to output of the reception apparatus detection signal.

The data about the reference value related to a variation of current, data about the reference value related to the quality factor Q, and/or data about the reference value related to signal intensity of the response signal, which are stored in the memory 140, may include a factory-calibrated data value in relation to various positions of the wireless power reception apparatus 200.

For example, the memory 140 may store a variation of current, which is calculated for each of the plurality of coils LA1 to LA4 in relation to various positions of an object, as a reference value related to the variation of current.

For example, the memory 140 may store a quality factor Q calculated for each of the plurality of coils LA1 to LA4 in relation to various positions of the wireless power reception apparatus 200, as a reference value related to the quality factor Q.

For example, the memory 140 may store signal intensity of a response signal, which is calculated for each of the plurality of coils LA1 to LA4 in relation to various positions of the wireless power reception apparatus 200, as a reference value related to signal intensity of a response signal to the reception apparatus detection signal.

For example, the memory 140 may store data about a moving direction corresponding to a position of an object with respect to a charge region.

For example, the memory 140 may also store data about a moving distance corresponding to the position of the object with respect to the charge region. In this case, the memory 140 may store data about a moving distance corresponding to a variation of current flowing in the plurality of coils LA1 to LA4, data about a moving distance corresponding to a quality factor Q of the plurality of coils LA1 to LA4, and/or data about a moving distance corresponding to signal intensity of a response signal to the reception apparatus detection signal, received through the plurality of coils LA1 to LA4.

Each of the data stored in the memory 140 may also be stored as a data table about the plurality of coils LA1 to LA4.

The sensor 120 may detect current and voltage input to the coil assembly 190, temperature of the plurality of coils LA1 to LA4, or the like.

For example, when the coil assembly 190 includes the plurality of coils LA1 to LA4 and a plurality of capacitors (not shown) connected to a first group and a second group, respectively, among the plurality of coils LA1 to LA4, the sensor 120 may detect all of a voltage V1 applied to opposite ends of the capacitors, and a voltage V2 applied to opposite ends of the coils.

Meanwhile, the sensor 120 may sense a current flowing through a switching device of the inverter 165.

To this end, the sensor 120 may include an output current detector E. A current io detected by the output current detector E may be input to the controller 170.

The first and second communication circuits 130a and 130b may communicate with the wireless power reception apparatus 200.

The first communication circuit 130a may communicate using a first communication method. The first communication circuit 130a may transmit a signal including data about the state of a device, data about the amount of electricity used, and the like, to the wireless power reception apparatus 200, and may receive a signal including data about the state of the device, data about the amount of electricity used, data about battery charge, and the like, from the wireless power reception apparatus 200.

The second communication circuit 130b may communicate with the wireless power reception apparatus 200 using a second communication method that is different from the first communication method. The second communication circuit 130b may transmit a signal including data about the state of a device, data about the amount of electricity used, and the like, to the wireless power reception apparatus 200, and may receive a signal including data about the state of a device, data about the amount of electricity used, data about battery charge, and the like, from the wireless power reception apparatus 200.

For example, the first and second communication circuits 130a and 130b may further include a modulator and demodulator (not shown) for modulating and demodulating the signal transmitted from the wireless power transfer apparatus 100 and the signal received from the wireless power reception apparatus 200.

The first and second communication circuits 130a and 130b may further include a filter (not shown) for filtering the signal received from the wireless power reception apparatus 200. In this case, the filter may include a band pass filter (BPF).

The first communication method may be an in-band communication method using the same frequency band as the wireless power reception apparatus 200. The second communication method may be an out-of-band communication method using a different frequency band from the wireless power reception apparatus 200.

A communication method used in the wireless power transfer apparatus 100 may be changed to at least one of the first and second communication methods based on data about the wireless power reception apparatus 200.

An output device 180 may include a display device a display or a light emitting diode (LED) and/or an audio device a speaker or a buzzer.

The controller 170 may be connected to components included in the wireless power transfer apparatus 100, and the controller 170 may transmit and receive a signal between the components included in the wireless power transfer apparatus 100 and may control an overall operation of the components.

The controller 170 may communicate with the wireless power reception apparatus 200 through at least one of the first and second communication circuits 130a and 130b.

The controller 170 may include a pulse width modulation (PWM) generator 170a for generating a PWM signal, and a driver 170b for generating a driving signal Sic and outputting the driving signal Sic to the wireless power driver 160 based on the PWM signal.

The wireless power driver 160 may include an inverter 165 including a plurality of switching devices Sa, Sb, S′a, and S′b for converting DC power to AC power.

For example, when the switching device is an IBGT, the driving signal Sic output from the driver 170b may be input to gate terminals of the switching devices Sa, Sb, S′a, and S′b.

Meanwhile, the switching devices Sa, Sb, S′a, and S′b included in the inverter 165 of the wireless power driver 160 may perform a switching operation according to the driving signal Sic, and DC power may be converted into AC power and may be output to the coil assembly 190 through the switching operation of the switching devices Sa, Sb, S′a, and S′b.

The coil assembly 190 may include the plurality of coils LA1 to LA4. For example, the plurality of coils LA1 to LA4 included in the coil assembly 190 may partially overlap each other.

For example, the plurality of coils LA1 to LA4 may be spaced apart from the reception coil LB included in the wireless power reception apparatus 200, and thus leakage inductance may be increased and a coupling factor is lowered, thereby lowering transfer efficiency.

To overcome the problem, the coil assembly 190 included in the wireless power transfer apparatus 100 according to various embodiments of the present disclosure may further include a plurality of capacitor devices (not shown) that are connected to the plurality of coils LA1 to LA4, respectively, and may form a resonance circuit with the reception coil LB included in the wireless power reception apparatus 200.

The plurality of capacitor devices may be connected in series to the plurality of coils LA1 to LA4, respectively. In some embodiments, the plurality of capacitor devices may be connected in parallel to the plurality of coils LA1 to LA4, respectively to form a resonance circuit.

The coil assembly 190 may determine a resonance frequency for wireless power transfer.

The coil assembly 190 may further include a shielding material (not shown) that is disposed at one side of the plurality of coils LA1 to LA4 and shields a leakage magnetic field.

The controller 170 may transmit and receive a signal through the plurality of coils LA1 to LA4 included in the coil assembly 190.

The controller 170 may control each of the components included in the wireless power transfer apparatus 100 to output an object detection signal for determining presence of an object positioned within a charge region through the plurality of coils LA1 to LA4. The object detection signal may be an analog ping (AP) signal with a very short pulse. The controller 170 may output an analog ping (AP) signal through the plurality of coils LA1 to LA4 in a predetermined order.

The controller 170 may calculate a variation of current flowing in each of the plurality of coils LA1 to LA4 according to output of the object detection signal. The controller 170 may detect current flowing in each of the plurality of coils LA1 to LA4 through the sensor 120, and may calculate a variation of current flowing in each of the plurality of coils LA1 to LA4 based on the detected current.

The controller 170 may determine whether an object is present in the charge region and a position of the object in the charge region based on a variation of current flowing in each of the plurality of calculated coils LA1 to LA4.

For example, the controller 170 may compare variations of currents flowing in the plurality of coils LA1 to LA4 calculated according to output of the analog ping (AP) signal, and may determine whether an object is present in the charge region and a position of the object in the charge region based on the comparison result.

For example, the controller 170 may compare a variation of current flowing in each of the plurality of coils LA1 to LA4, calculated according to output of the analog ping (AP) signal, with a reference value related to the variation of current, stored in the memory 140, and may determine whether an object is present in the charge region and a position of the object in the charge region based on the comparison result.

A reference value related to a variation of current as a reference for determining whether an object is present in a charge region and a reference value related to a variation of current as a reference for determining whether the object is positioned at a position at which power is not capable of being transferred may be different from each other. When an object is positioned in a region corresponding to any one of the plurality of coils LA1 to LA4 in the charge region, the reference value related to a variation of current as the reference for determining whether an object is present in the charge region may be a value less than the reference value related to a variation of current as the reference for determining whether the object is positioned at a position at which power is capable of being transferred.

The controller 170 may control each of components included in the wireless power transfer apparatus 100 to output a reception apparatus detection signal for awaking the wireless power reception apparatus 200 through the plurality of coils LA1 to LA4. The reception apparatus detection signal may be a digital ping (DP) signal.

The digital ping (DP) signal may be set to have a higher duty than the analog ping (AP) signal in order to attempt to set communicate with the wireless power reception apparatus 200.

For example, the controller 170 may output a digital ping (DP) signal through the plurality of coils LA1 to LA4 in a predetermined order.

The controller 170 may receive a response signal to the reception apparatus detection signal, output from the wireless power reception apparatus 200, through the plurality of coils LA1 to LA4. The wireless power reception apparatus 200 may modulate the digital ping (DP) signal and may transmit the modulated digital ping (DP) signal as a response signal to the wireless power transfer apparatus 100.

The controller 170 may determine whether an object positioned in the charge region is the wireless power reception apparatus 200 based on the response signal to the reception apparatus detection signal. The controller 170 may demodulate the modulated digital ping (DP) signal received as the response signal to acquire digital-form data and may determine whether the object positioned in the charge region is the wireless power reception apparatus 200 based on the acquired data.

The controller 170 may calculate signal intensity of a response signal to the reception apparatus detection signal with respect to each of the plurality of coils LA1 to LA4 and may determine a position of an object in the charge region based on the calculated signal intensity of the response signal.

For example, the controller 170 may compare signal intensity of the response signal, calculated for each of the plurality of coils LA1 to LA4, with a reference value related to signal intensity of the response signal, stored in the memory 140, and may determine a position of an object in the charge region according to the comparison result.

The controller 170 may calculate a quality factor Q of each of the plurality of coils LA1 to LA4. The controller 170 may detect a voltage V1 applied to a coil and a capacitor and a voltage V2 applied to opposite ends of the coil through the sensor 120 and may calculate the quality factor Q of each of the plurality of coils LA1 to LA4 based on the detected voltages.

According to the present disclosure, although the case in which the voltage V1 applied to the coil and the capacitor and the voltage V2 applied to opposite ends of the coil are detected in order to calculate the quality factor Q is described, the present disclosure is not limited thereto, and the voltage V2 applied to the opposite ends of the coil and a voltage V3 applied to opposite ends of the capacitor may also be detected to calculate the quality factor Q.

In detail, the controller 170 may calculate the quality factor Q of each of the plurality of coils LA1 to LA4 using Equation 1 below.

$$Q i = \frac{V 2}{V 1} \qquad [ Equation 1 ]$$

Here, Qi may refer to a quality factor Q of each of the plurality of coils LA1 to LA4. A quality factor Q of the first coil LA may be a value obtained by dividing the voltage V2 applied to the opposite ends of the first coil LA by the voltage V1 applied to the first coil LA and the capacitor connected to the first coil LA.

The controller 170 may determine whether an object positioned in the charge region is the wireless power reception apparatus 200 based on the quality factor Q of each of the plurality of coils LA1 to LA4.

Specifically, when frequency sweep occurs to a high frequency from a low frequency within an operating frequency (or available frequency) band, the voltage V1 applied to the coil and the capacitor may not be generally changed despite frequency sweep but may be slightly reduced at a time point at which an object is present in the charge region. The voltage V2 applied to the opposite ends of the coil may be changed to be gradually increased and then lowered according to frequency sweep.

The controller 170 may calculate a maximum value of a ratio of the voltage V1 applied to the coil and the capacitor to the voltage V2 applied to the opposite ends of the coil, which is changed according to frequency sweep, as a quality factor Q of a corresponding coil in a resonance frequency.

The controller 170 may compare the quality factor Q of the plurality of coils LA1 to LA4 with a reference value related to the quality factor Q stored in the memory 140 and may determine whether an object positioned in the charge region is the wireless power reception apparatus 200 according to the comparison result. In this case, when determining that the object positioned in the charge region is not the wireless power reception apparatus 200, the controller 170 may determine that the corresponding object is a foreign object (FO).

The controller 170 may compare total sum of quality factors Q of the plurality of coils LA1 to LA4 with the reference value related to the quality factor Q stored in the memory 140 and may determine whether the object positioned in the charge region is the wireless power reception apparatus 200 according to the comparison result.

The controller 170 may determine a position of an object in the charge region based on the quality factor Q of the plurality of coils LA1 to LA4. The controller 170 may compare the quality factor Q of each of the plurality of coils LA1 to LA4 with the reference value related to the quality factor Q stored in the memory 140 and may determine a position of an object in the charge region according to the comparison result.

The controller 170 may control each of the components included in the wireless power transfer apparatus 100 and may transfer power to the wireless power reception apparatus 200 through the coil assembly 190.

The controller 170 may determine a combination of coils including at least one of the plurality of coils LA1 to LA4. In addition, the controller 170 may transmit and receive a signal and may wirelessly transmit power through the determined combination of coils.

Power is transferred according to a combination of coils including at least one of the plurality of coils LA1 to LA4 included in the coil assembly 190, and thus the coil assembly 190 may be referred to as a transfer coil part or a coil part. Each of the plurality of coils LA1 to LA4 included in the coil assembly 190 may be referred to as a transfer coil in order to differentiate from the reception coil LB included in the wireless power reception apparatus 200.

The controller 170 may output a message through the output device 180. The controller 170 may output a message through a display device included in the output device 180. The controller 170 may output a message through an audio device included in the output device 180.

The controller 170 may output a message of a moving direction toward a position with higher wireless power transfer efficiency from the current position of an object based on data about a moving direction corresponding to a position of the object, stored in the memory 140. The controller 170 may output a message of a moving distance toward a position with higher power transfer efficiency from the current position of an object based on data about a moving distance corresponding to a position of the object, stored in the memory 140. As such, a user may be guided to change a position of an object, thereby increasing power transfer efficiency.

The controller 170 may also stop transferring power based on values detected through the sensor 120.

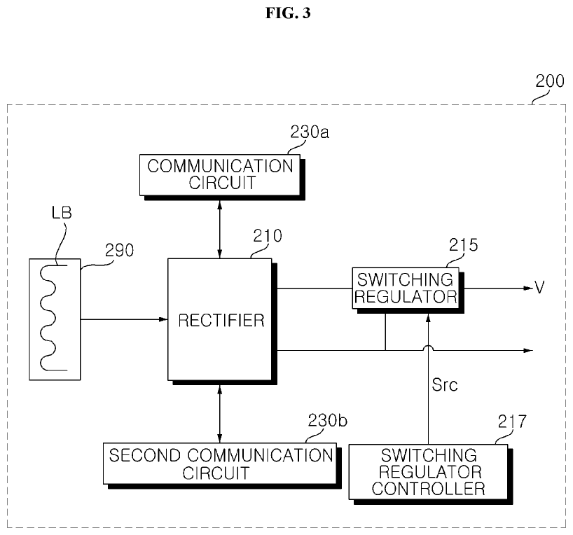

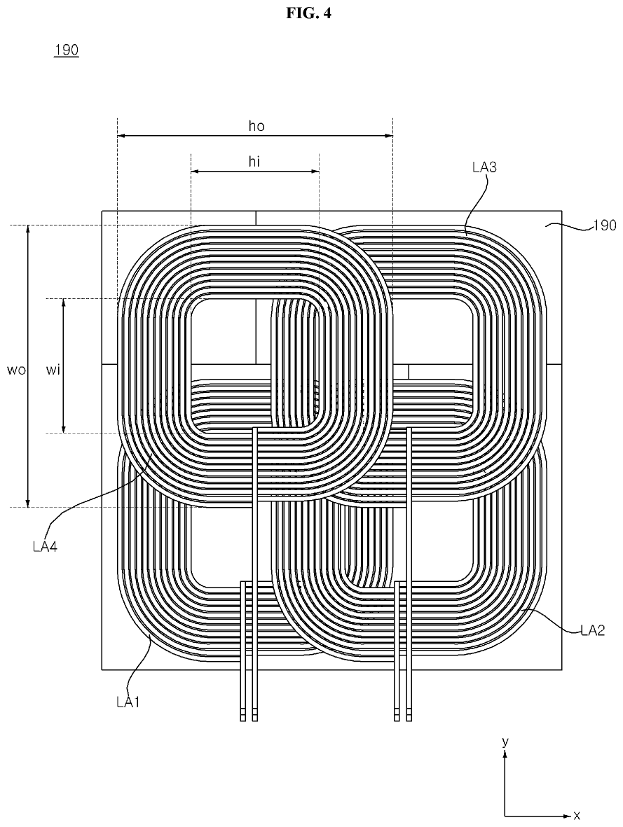

FIG. 3 is an internal block diagram of a wireless power reception apparatus of FIG. 1.

Referring to FIG. 3, the wireless power reception apparatus 200 may include a coil assembly 290 for wirelessly receiving power from the wireless power transfer apparatus 100, a rectifier 210 for rectifying the received power, a switching regulator 215 for stabilizing the rectified power, and/or a switching regulator controller 217 for controlling the switching regulator 215 and outputting operating power to a load.

The wireless power reception apparatus 200 may further include a first communication circuit 230a and a second communication circuit 230b for communicating with the wireless power transfer apparatus 100.

The coil assembly 290 may receive power transferred from the coil assembly 190. To this end, the coil assembly 290 may include at least one reception coil LB. Hereinafter, the reception coil LB included in the coil assembly 290 may be referred to as a reception coil.

The reception coil LB may generate induced electromotive force by a magnetic field generated from at least one of the plurality of coils LA1 to LA4. Power due to induced electromotive force may be supplied to a load through the rectifier 210 and the switching regulator 215.

For example, when the load is a battery, power due to induced electromotive force may be used to charge a battery. According to the present disclosure, although the case in which a load to which power is supplied through the rectifier 210 and the switching regulator 215 is a battery is described, the present disclosure is not limited thereto.

The reception coil LB may be formed in a thin film-type conductive pattern on a printed circuit board (PCB). The reception coil LB may be printed on a pad (not shown) in the form of a closed loop. For example, the reception coil LB may be wound to have polarity in the same direction.

The wireless power reception apparatus 200 may further include at least one capacitor (not shown) for forming a resonance circuit with the coil assembly 190 included in the wireless power transfer apparatus 100. In this case, the capacitor may be connected in series or in parallel to the reception coil LB.

The wireless power reception apparatus 200 may further include a shielding material (not shown) that is disposed at one side of the reception coil LB and shields a leakage magnetic field.

The rectifier 210 may rectify power received through the reception coil LB. The rectifier 210 may include at least one diode (not shown).

The switching regulator 215 may supply the power rectified by the rectifier 210 to a battery under control of the switching regulator controller 217. The switching regulator 215 may output the power rectified by the rectifier 210 as charging power (v) supplied to a battery.

The switching regulator controller 217 may perform control to output a regulator control signal Src to the switching regulator 215 and to output the charging power (v) to the battery.

The switching regulator 215 may perform DC-DC converting and may adjust output voltage according to the regulator control signal Src of the switching regulator controller 217. The switching regulator 215 may output the charging power (v) having a voltage with predetermined amplitude based on the regulator control signal Src.

The wireless power reception apparatus 200 may not include a separate processor, and when the rectified charging power (v) is output as a voltage with predetermined amplitude by the switching regulator 215, the switching regulator 215 may be controlled by the switching regulator controller 217. When the wireless power reception apparatus 200 does not include a processor, the hardware configuration may be simplified and power consumption may be reduced.

FIG. 4 is a diagram illustrating an example of a plurality of coils included in a wireless power transfer apparatus, and FIG. 5 is a diagram illustrating a hierarchical structure of the plurality of coils of FIG. 4.

Referring to FIGS. 4 and 5, the coil assembly 190 according to an embodiment of the present disclosure may include the plurality of coils LA1 to LA4.

The coil assembly 190 includes the plurality of coils, for example, the first to fourth coils LA1 to LA4 but not a single large-size coil, and thus, needless to say, a degree of freedom of a charging may be increased, and power efficiency may be prevented from being lowered due to stray magnetic fields of a large-size coil.

The plurality of coils LA1 to LA4 may be arranged in such a way that some regions thereof overlap each other.

Particularly, the plurality of coils LA1 to LA4 may be arranged to overlap each other to minimize a dead zone as a region from which power is not transferred to the wireless power reception apparatus 200 in a charge region corresponding to the first to fourth coils LA1 to LA4. The first to fourth coils LA1 to LA4 may be arranged to overlap each other to minimize a dead zone of a central portion of the charge region.

The first to fourth coils LA1 to LA4 may be manufactured with an outer length ho, an internal length hi, an outer width wo, an internal width wi, a thickness, and the number of coils, which are preset. The first to fourth coils LA1 to LA4 may have the same outer length ho, the same internal length hi, the same outer width wo, and the same internal width wi.

Inductance of the fourth coil LA4 disposed the most adjacent to the wireless power reception apparatus 200 may be set to be less than inductance of the first to third coils LA1 to LA3. As such, power transfer rate or efficiency of the coil assembly 190 may be constant.

The coil assembly 190 may further include a shielding material (not shown). The first to fourth coils LA1 to LA4 may be disposed on the shielding material (not shown).

The shielding material (not shown) may include ferrite including a combination of one or two elements or more selected from the group consisting of cobalt (Co), iron (Fe), nickel (Ni), boron (B), or silicon (Si). The shielding material (not shown) may be disposed at one side of a coil, may shield a leakage magnetic field, and may maximize the directivity of a magnetic field.

An area of the shielding material (not shown) may be larger than an area in which the first to fourth coils LA1 to LA4 are arranged.

Meanwhile, in FIG. 5, the first coil LA1 may be disposed at a lowermost position, and the second coil LA2, the third coil LA3, and the fourth coil LA2 may be arranged sequentially in an upward direction (z-axis direction).

In this case, the first to fourth coils LA1 to LA4 are spaced apart from each other in the z-axis direction, and may partially overlap each other in the x-axis direction or the y-axis direction.

In FIG. 5, an example is illustrated in which the first to fourth coils (LA1 to LA4) overlap each other by an area Arc.

In FIG. 4, an example is illustrated in which with respect to the x-axis direction and y-axis direction, the first coil LA1 is located at the left bottom, the second coil LA2 is located at the right bottom, the third coil LA3 is located at the right top, and the fourth coil LA4 is located at the left top.

Meanwhile, in FIG. 4, an example is illustrated in which the first to fourth coils LA1 to LA4 partially overlap each other in the x-axis or y-axis direction. Accordingly, it is possible to reduce a dead zone from which power is not transferred to the wireless power reception apparatus 200.

The first to fourth coils LA1 to LA4 may be accommodated within a case that is not illustrated for convenience of description. For example, the wireless power reception apparatus 200 may be positioned on one lateral surface of the case. When the wireless power reception apparatus 200 is positioned on one lateral surface of the case, the coil assembly 190 may wirelessly transfer power to charge the wireless power reception apparatus 200, and thus, the one lateral surface on which the wireless power reception apparatus 200 is positioned may be referred to as a charging surface. In addition, the charging surface and an interface surface may be interchangeably used.

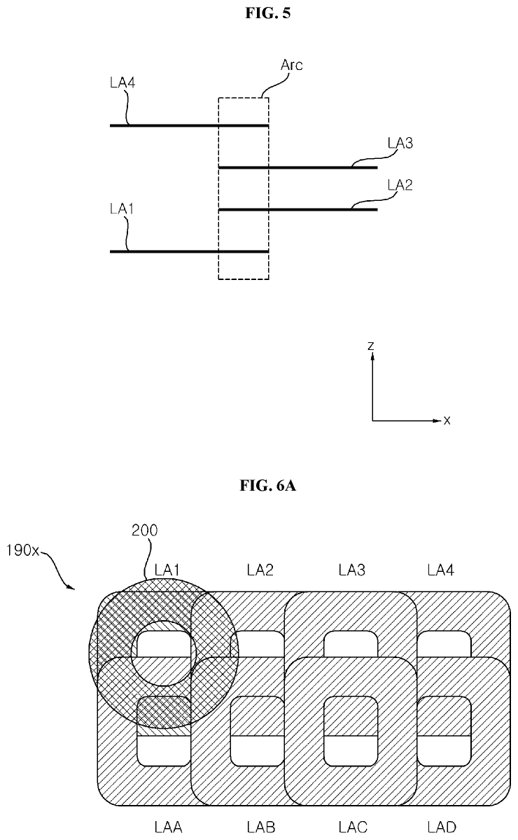

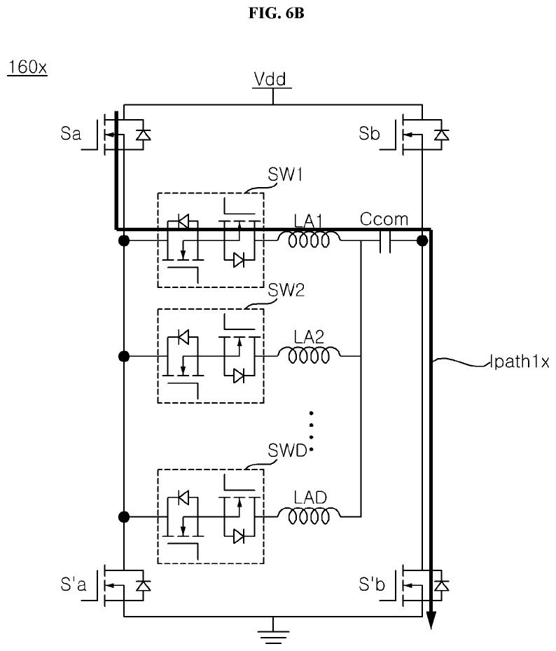

FIG. 6A is a diagram illustrating an example of a coil assembly associated with the present disclosure, and FIG. 6B is a diagram illustrating an example of a wireless power driver corresponding to the coil assembly of FIG. 6a.

Referring to the drawing, FIG. 6A illustrates an example in which among a plurality of coils LA1 to LAD, some coils LA1 to LA4 are arranged in a first row while partially overlapping each other, and other coils LAA to LAD are arranged in a second row while partially overlapping each other.

Particularly, FIG. 6A illustrates an example in which the wireless power reception apparatus 200 is disposed at a position corresponding to the first coil LA1.

If eight coils LA1 to LAD are used as illustrated in FIG. 6A, a wireless power driver 160x for wireless power transfer may include one resonant capacitor Ccom, and coil switching devices SW1 to SWD corresponding to the respective eight coils LA1 to LAD as illustrated in FIG. 6B.

Meanwhile, as the wireless power reception apparatus 200 is disposed at a position corresponding to the first coil LA1 in FIG. 6A, it is preferred that only the first coil LA1 is driven.

In FIG. 6B, in order to drive only the first coil LA1, only the first coil switching device SW1 is turned on among the plurality of coil switching devices SW1 to SWD, such that a current Ipath1x flows through the switching device S′b in the inverter 165.

However, the use of the wireless power driver 160x has a drawback in that one resonant capacitor Ccom is used, increasing the possibility of burn damage to the resonant capacitor Ccom, and it takes considerable time to select coils from among the eight coils LA1 to LAD, since the eight coils LA1 to LAD are required to be driven sequentially one by one.

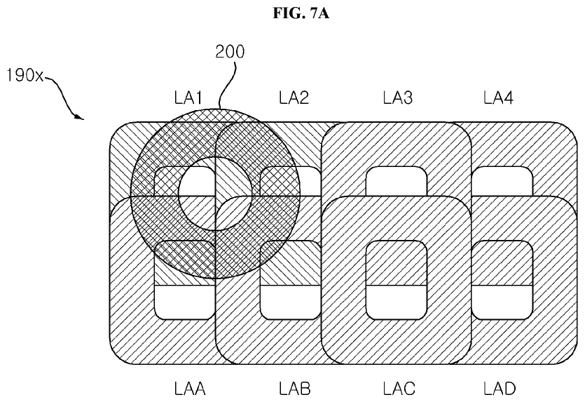

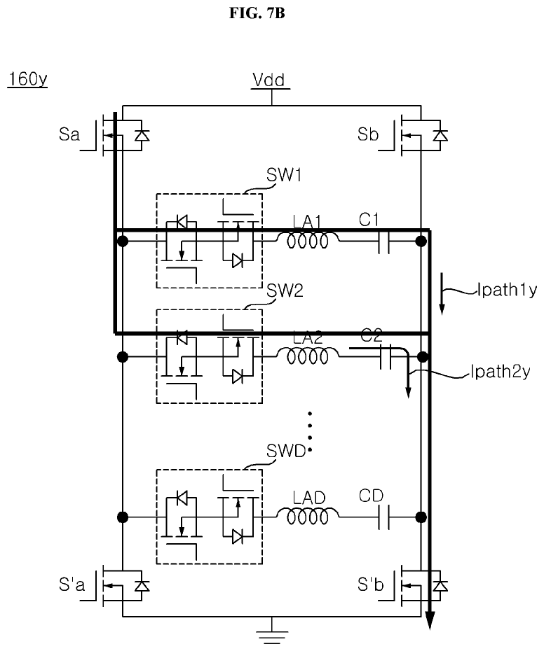

FIG. 7A is a diagram illustrating an example of a coil assembly associated with the present disclosure, and FIG. 7B is a diagram illustrating another example of wireless power driver corresponding to the coil assembly of FIG. 7A.

Referring to the drawing, FIG. 7A illustrates an example in which among a plurality of coils LA1 to LAD in the coil assembly 190x, some coils LA1 to LA4 are arranged in a first row while partially overlapping each other, and other coils LAA to LAD are arranged in a second row while partially overlapping each other.

Particularly, FIG. 7A illustrates an example in which the wireless power reception apparatus 200 is disposed at a position corresponding to the first coil LA1 and the second coil LA2.

If eight coils LA1 to LAD are used as illustrated in FIG. 7A, a wireless power driver 160y for wireless power transfer may include coil switching devices SW1 to SWD corresponding to the respective eight coils LA1 to LAD, and a plurality of resonant capacitors C1 to CD connected to the respective eight coils LA1 to LAD as illustrated in FIG. 7B. That is, eight resonant capacitors C1 to CD may be used.

Meanwhile, as the wireless power reception apparatus 200 is disposed at a position corresponding to the first coil LA1 and the second coil LA2 in FIG. 7A, it is preferred that only the first coil LA1 and the second coil LA2 are driven.

In FIG. 7B, in order to drive only the first coil LA1 and the second coil LA2, only the first coil switching device SW1 and the second coil switching device SW2 are turned on among the plurality of coil switching devices SW1 to SWD, such that currents Ipath1x and Ipath1y flow through the switching device S′b in the inverter 165.

However, the use of the wireless power driver 160y has a drawback in that eight resonant capacitors C1 to CD are used, resulting in a complicated circuit configuration and an increase in volume and the like, and it takes considerable time to select coils from the eight coils LA1 to LAD, since the eight coils LA1 to LAD are required to be driven sequentially one by one.

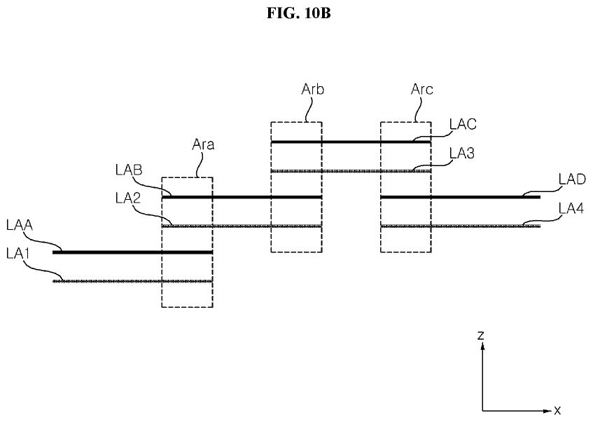

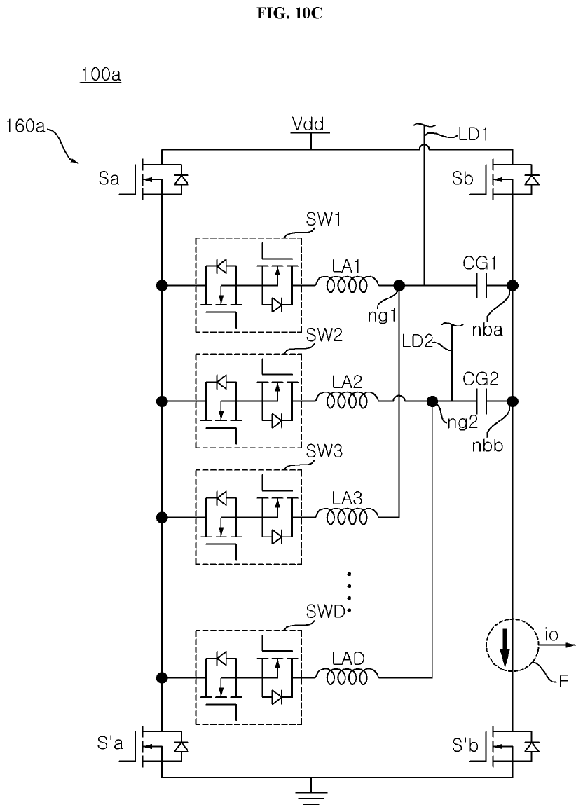

Accordingly, the present disclosure proposes a method of reducing a coil selection period while simply implementing a circuit, when a plurality of coils are used in the wireless power transfer apparatus, which will be described later with reference to FIG. 10A and the following figures.

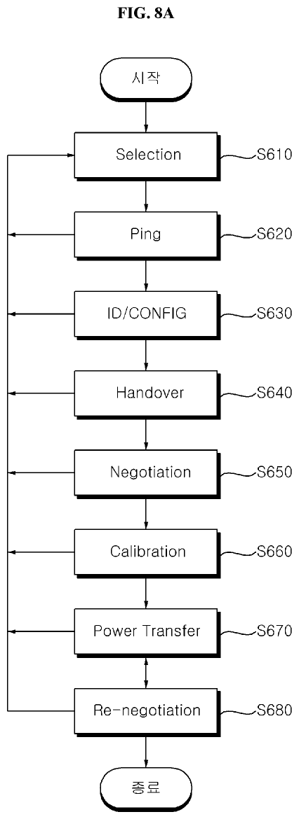

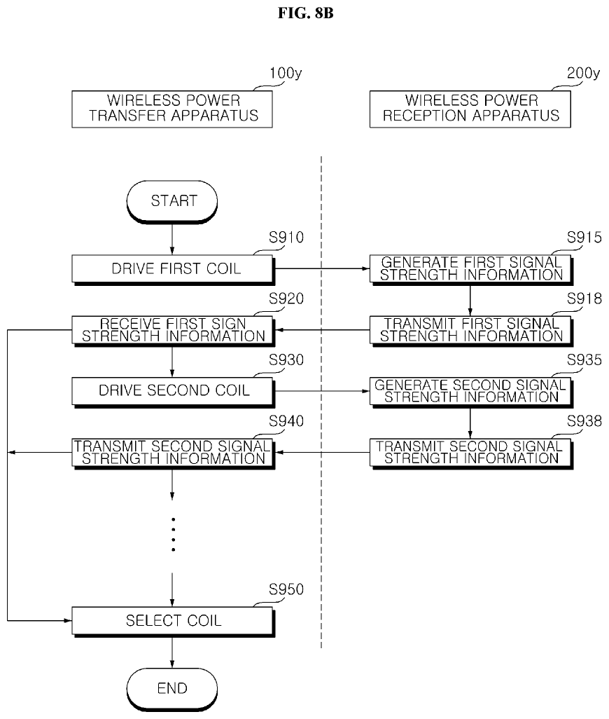

FIG. 8A is a flowchart illustrating an example of a wireless power transfer method of a wireless power transfer apparatus associated with the present disclosure.

Referring to the drawing, the wireless power transfer method may include a selection phase S610, a ping phase S620, an identification and configuration phase S630, a handover phase S640, a negotiation phase S650, a calibration phase S660, a power transfer phase S670, and a re-negotiation phase S680.

First, in the selection phase S610, the wireless power transfer apparatus 100 may determine whether an object is present in a charge region.

In order to determine whether an object is present in the charge region, the wireless power transfer apparatus 100 may output an object detection signal (e.g., an analog ping (AP) signal) and may determine whether an object is present in the charge region based on output of the object detection signal.

The wireless power transfer apparatus 100 may output an object detection signal with a predetermined period until determining the object to be present in the charge region.

The wireless power transfer apparatus 100 may output the object detection signal in a predetermined order through the plurality of coils LA1 to LA4 and may determine whether an object is present in the charge region based on a variation of current flowing in each of the plurality of coils LA1 to LA4.

For example, the wireless power transfer apparatus 100 may compare a variation of current flowing in each of the plurality of coils LA1 to LA4 with a preset reference value and may determine the object to be positioned in a region corresponding to a coil in which a current variation equal to or greater than the preset reference value is calculated among the plurality of coils LA1 to LA4. In this case, the coil in which the current variation equal to or greater than the preset reference value may be referred to as an active coil.

In the selection phase S610, the wireless power transfer apparatus 100 may determine whether a foreign object FO is present in the charge region. The foreign object FO may be a metallic object such as a coin or a key.

In the selection phase S610, the wireless power transfer apparatus 100 may continuously detect arrangement or removal of an object in the charge region.

In the selection phase S610, when determining that the object is present in the charge region, the wireless power transfer apparatus 100 may perform the selection phase S620.

In the selection phase S620, the wireless power transfer apparatus 100 may identify whether the object positioned in the charge region is the wireless power reception apparatus 200 and may transmit a reception apparatus detection signal (e.g., a digital ping (DP) signal) for awaking the wireless power reception apparatus 200.

The wireless power transfer apparatus 100 may receive a response signal to the reception apparatus detection signal. The wireless power reception apparatus 200 may modulate a digital ping (DP) signal and may transmit the modulated digital ping (DP) signal as a response signal to the wireless power transfer apparatus 100.

The wireless power transfer apparatus 100 may determine whether the object positioned in the charge region is the wireless power reception apparatus 200 based on a response signal to the reception apparatus detection signal. The wireless power transfer apparatus 100 may demodulate the modulated digital ping (DP) signal received as the response signal to acquire digital-form data and may determine whether the object positioned in the charge region is the wireless power reception apparatus 200 based on the acquired data.

In the selection phase S620, when the object positioned in the charge region is determined to be the wireless power reception apparatus 200, the identification and configuration phase S630 may be performed.

In the selection phase S620, when a response signal is not received, the wireless power transfer apparatus 100 may proceed to the selection phase S610 and may perform each operation of the selection phase S610.

In the identification and configuration phase S630, the wireless power transfer apparatus 100 may control each component included therein to effectively transfer power based on data received from the wireless power reception apparatus 200.

In the identification and configuration phase S630, the wireless power transfer apparatus 100 may receive identification data from the wireless power reception apparatus 200. The identification data may include data about a version of a wireless power transfer rule, data about a manufacturer of the wireless power reception apparatus 200, a device identifier, or data indicating whether an expansion device identifier is present.

In the identification and configuration phase S630, the wireless power transfer apparatus 100 may receive power data from the wireless power reception apparatus 200. The power data may include data about maximum power of the wireless power reception apparatus 200, data about remaining power, or data about a power class.

The wireless power transfer apparatus 100 may identify the wireless power reception apparatus 200 and may check the state of power of the wireless power reception apparatus 200 based on the identification data and the power data.

In the identification and configuration phase S630, when the wireless power transfer apparatus 100 identifies the wireless power reception apparatus 200 and checks the state of power of the wireless power reception apparatus 200, the handover phase S640 may be performed.

In the identification and configuration phase S630, when the wireless power transfer apparatus 100 does not receives identification data and/or power data, the wireless power transfer apparatus 100 may proceed to the selection phase S610.

In the handover phase S640, the wireless power transfer apparatus 100 may determine whether a communication method with the wireless power reception apparatus 200 is changed.

For example, in a state in which the wireless power transfer apparatus 100 communicates with the wireless power reception apparatus 200 using an in-band communication method, the wireless power transfer apparatus 100 may determine whether the in-band communication method is maintained or whether the in-band communication method is changed to an out-of-band communication method based on the power data of the wireless power reception apparatus 200 acquired in the identification and configuration phase S630.

The wireless power transfer apparatus 100 may determine whether entry into the negotiation phase S650 is required based on a negotiation field value received in the identification and configuration phase S630 or the handover phase S640.

For example, when entry into the negotiation phase S650 is required, the wireless power transfer apparatus 100 may perform a foreign object detection (FOD) operation in the negotiation phase S650.

The wireless power transfer apparatus 100 may determine whether the calibration phase S660 is performed based on whether the foreign object FO is present in the charge region, which is determined in the selection phase S610 and/or the negotiation phase S650.

For example, when entry into the negotiation phase S650 is not required, the wireless power transfer apparatus 100 may perform the power transfer phase S670.

When the foreign object FO is not detected in the selection phase S610 and/or the negotiation phase S650, the wireless power transfer apparatus 100 may perform the power transfer phase S670 through the calibration phase S660.

When the foreign object FO is detected in the selection phase S610 and/or the negotiation phase S650, the wireless power transfer apparatus 100 may proceed to the selection phase S610 without power transfer.

In the calibration phase S660, the wireless power transfer apparatus 100 may calculate power loss based on a difference between transferred power of the wireless power transfer apparatus 100 and received power of the wireless power reception apparatus 200.

In the power transfer phase S670, the wireless power transfer apparatus 100 may transfer power to the wireless power reception apparatus 200.

In the power transfer phase S670, when receiving data related to power control from the wireless power reception apparatus 200 during power transfer, the wireless power transfer apparatus 100 may determine the characteristics of power based on data related to control of received power.

In the power transfer phase S670, the wireless power transfer apparatus 100 proceeds to the selection phase S610 when unexpected data is received, when expected data, e.g., data related to power control is not received for a preset time (time out), when preset power transfer contract violation occurs, or when charging is completed.

In the power transfer phase S670, the wireless power transfer apparatus 100 may perform the re-negotiation phase S680 when power transfer negotiation needs to be reconfigured according to a change in the state of the wireless power transfer apparatus 100 and/or the wireless power reception apparatus 200, or the like. In this case, when renegotiation is normally completed, the wireless power transfer apparatus 100 may return to the power transfer phase S670.

FIG. 8B is a flowchart illustrating an example of an operation method of the wireless power driver of FIG. 7B.

Referring to the drawing, a wireless power transfer apparatus 100y including the wireless power driver 160y of FIG. 7B drives the first coil LA1 among the plurality of coils LA1 to LAD (S910). That is, the wireless power transfer apparatus 100y controls the coil switching device SW1, corresponding to the first coil LA1, to be turned on.

Accordingly, wireless power, transferred by driving the first coil LA1, is transferred to a wireless power reception apparatus 200y.

The wireless power reception apparatus 200y detects a first signal strength in response to the driving of the first coil LA1 of the wireless power transfer apparatus 100y, and generates first signal strength information (S915).

Then, the wireless power reception apparatus 200y transmits the first signal strength information to the wireless power transfer apparatus 100y (S918).

Accordingly, the wireless power transfer apparatus 100y receives the first signal strength information (S920).

Subsequently, the wireless power transfer apparatus 100y drives the second coil LA2 among the plurality of coils LA1 to LAD (S930). That is, the wireless power transfer apparatus 100y controls the coil switching device SW2, corresponding to the second coil LA2, to be turned on.

Accordingly, wireless power, transferred by driving the second coil LA2, is transferred to the wireless power reception apparatus 200y.

The wireless power reception apparatus 200y detects a second signal strength in response to the driving of the second coil LA2 of the wireless power transfer apparatus 100y, and generates second signal strength information (S935).

Then, the wireless power reception apparatus 200y transmits the second signal strength information to the wireless power transfer apparatus 100y (S938).

Accordingly, the wireless power transfer apparatus 100y receives the second signal strength information (S940).

Next, the wireless power reception apparatus 200y drives the remaining coils sequentially one by one among the plurality of coils LA1 to LAD, and receives signal strength information of the respective remaining coils from the wireless power reception apparatus 200y.

Then, based on the received plurality of pieces of signal strength information, the wireless power transfer apparatus 100y selects at least one coil from among the plurality of coils LA1 to LAD (S950).

Particularly, the wireless power transfer apparatus 100y may select a coil corresponding to a position of the wireless power reception apparatus 200y, and may drive the selected coil.

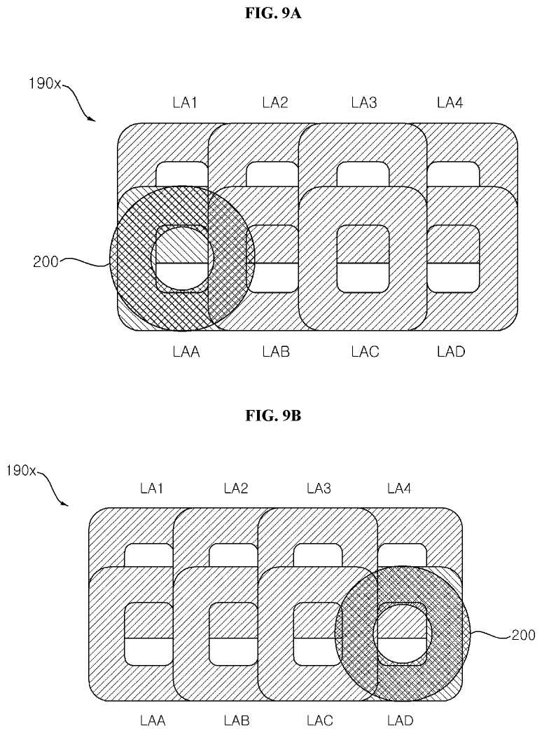

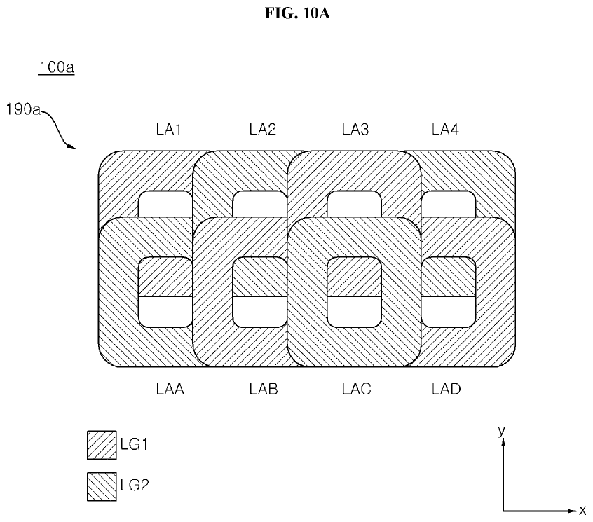

FIGS. 9A and 9B are diagrams referred to in the description of FIG. 8B.

First, FIG. 9A illustrates an example in which the wireless power reception apparatus 200 is located on a fifth coil LAA in the coil assembly 190x, and FIG. 9B illustrates an example in which the wireless power reception apparatus 200 is located on an eighth coil LAD in the coil assembly 190x.

The use of the wireless power driver 160y of FIG. 7B as the coil assembly 190x of FIGS. 9A and 9B has a drawback in that eight resonant capacitors C1 to CD are used, resulting in a complicated circuit configuration and increasing a circuit size and the like, and it takes considerable time to select coils from the eight coils LA1 to LAD, since the eight coils LA1 to LAD are required to be driven sequentially one by one.

Accordingly, the present disclosure proposes a method of reducing a coil selection period while simply implementing a circuit, when a plurality of coils are used in the wireless power transfer apparatus.

FIG. 10A is a diagram illustrating an example of a coil assembly according to an embodiment of the present disclosure.

Referring to the drawing, a coil assembly 190a according to an embodiment of the present disclosure may include a plurality of coils LA1 to LAD. Particularly, the coil assembly 190a may include eight coils LA1 to LAD.

In the drawing, an example is illustrated in which some coils LA1 to LA4 among the plurality of coils LA1 to LAD are arranged in a first row while partially overlapping each other, and other coils LAA to LAD are arranged in a second row while partially overlapping each other.

Accordingly, it is possible to reduce a dead zone from which power is not transferred to the wireless power reception apparatus 200.

Meanwhile, in the embodiment of the present disclosure, a plurality of coils LA1 to LAD are divided into groups in order to simplify a circuit for selecting and operating at least some of the plurality of coils LA1 to LAD.

Particularly, the plurality of coils are grouped so that the number of groups of the plurality of coils LA1 to LAD is smaller than the number of the plurality of coils LA1 to LAD.

For example, among the plurality of coils LA1 to LAD, the first coil LA1 and a coil not adjacent to the first coil LA1 may be included in a first group LG1, and the second coil LA2 adjacent to the first coil LA1 and a coil not adjacent to the second coil LA2 may be included in a second group LG2.

In another example, among the plurality of coils LA1 to LAD, the first coil LA1 and a coil not adjacent to the first coil LA1 may be included in the first group LG1, and the second coil LA2 adjacent to the first coil LA1 may be included in a second group LG2.

In yet another example, among the plurality of coils LA1 to LAD, the first coil LA1 may be included in the first group LG1, and the second coil LA2 adjacent to the first coil LA1 and a coil not adjacent to the second coil LA2 may be included in the second group LG2.

In the drawing, an example in illustrated in which, among eight coils LA1 to LAD, coils LA1, LA3, LAB, and LAD are divided into the first group LG1, and coils LA2, LA4, LAA, and LAC are divided into the second group LG2.

By grouping the coils, a plurality of coils may be driven simultaneously by selecting at least one coil from each group, thereby significantly reducing a coil selection period. Further, wireless power may be stably transmitted even when the wireless power reception apparatus 200 is moved or wireless power is transmitted to a plurality of wireless power reception apparatuses 200.

FIG. 10B is a bottom view of the coil assembly of FIG. 10A.

Referring to the drawing, the first coil LA1 is disposed at a lowermost position, and a fifth coil LAA, a second coil LA2, a sixth coil LAB, a third coil LA3, and a seventh coil LAC may be arranged sequentially in an upward direction (z-axis direction).

Meanwhile, an eighth coil LAD and a fourth coil LA4 may be disposed below the third coil LA3 sequentially in a downward direction (-z axis direction).

In this case, the eighth coil LAD and the fourth coil LA4 may be disposed at the same height as the sixth coil LAB and the second coil LA2, respectively.

Meanwhile, in FIG. 10ad (10B?- [symbol] [symbol] illustrates an example in which the first to fourth coils LA1 to LA4 are arranged sequentially in the x-axis direction while partially overlapping each other, and the fifth to eighth coils LAA to LAD are arranged sequentially in the x-axis direction while partially overlapping each other, and partially overlapping lower portions of the first to fourth coils LA1 to LA4.

Accordingly, it is possible to reduce a dead zone from which power is not transferred to the wireless power reception apparatus 200.

FIG. 10C is a diagram illustrating an example of a wireless power transfer apparatus 100a including a wireless power driver 160a corresponding to the coil assembly of FIG. 10A.

Referring to the drawing, the wireless power driver 160a in the wireless power transfer apparatus 100 according to an embodiment of the present disclosure may include: a coil assembly 190a including a plurality of coils LA1 to LAD; a first resonant capacitor CG1 connected to a first group LG1 among the plurality of coils LA1 to LAD; and a second resonant capacitor CG2 connected to a second group LG2 among the plurality of coils LA1 to LAD, and connected in parallel to the first resonance capacitor CG1.

It is preferred that the number of groups of the plurality of coils LA1 to LAD is smaller than the number of the plurality of coils LA1 to LAD in the wireless power transfer apparatus 100.

Accordingly, a circuit for selecting and operating at least some of the plurality of coils LA1 to LAD may be simply implemented. Particularly, by using only the resonant capacitors CG1 and CG2 corresponding to the number of groups of the coils, the wireless power transfer apparatus 100 may be reduced in size while simply implementing the circuit. In addition, a plurality of wireless power reception apparatuses 200 may be charged wirelessly by driving the plurality of coils.

Meanwhile, among the plurality of coils LA1 to LAD, the first coil LA1 and a coil not adjacent to the first coil LA1 may be included in the first group LG1, and the second coil LA2 adjacent to the first coil LA1 and a coil not adjacent to the second coil LA2 may be included in the second group LG2.

In FIG. 10A, an example is illustrated in which among the plurality of coils LA1 to LAD, the first coil and the third coil LA3 not adjacent to the first coil in a first direction (x-axis direction) and a second direction (y-axis direction or-y axis direction) are included in the first group LG1; and among the plurality of coils LA1 to LAD, the second coil LA2 adjacent to the first coil in the first direction (x-axis direction) and the fourth coil LA4 not adjacent to the second coil LA2 may be included in the second group LG2. Accordingly, by grouping the coils not adjacent to each other, a wider area may be covered during wireless power transfer.

Meanwhile, the wireless power transfer apparatus 100 according to an embodiment of the present disclosure may further include coil switching devices SW1 to SWD connected to the respective coils LA1 to LAD.

For example, based on simultaneous turning on of coil switching devices SW1 to SWD of some coils in the first group LG1 and coil switching devices SW1 to SWD of some coils in the second group LG2 among the plurality of coils LA1 to LAD, a first current Ipath1 flows to the first resonant capacitor CG1, and a second current Ipath2 flows to the second resonant capacitor CG2. Accordingly, it is possible to simply implement a circuit for selecting and operating at least some of the plurality of coils LA1 to LAD. Particularly, the coils may be simply driven by group.

Specifically, during a first period, the first current Ipathl flows to the first resonant capacitor CG1 based on turning on of the first coil switching device SW1 in the first group LG1, and the second current Ipath2 flows to the second resonant capacitor CG2 based on turning on of the second coil switching device SW2 in the second group LG2.

Further, during a second period following the first period, the first current flows to the first resonant capacitor CG1 and the second current flows to the second resonant capacitor CG2, based on simultaneous turning on of the coil switching devices SW1 to SWD of other coils in the first group LG1 and the coil switching devices SW1 to SWD of some coils in the second group LG2 among the plurality of coils LA1 to LAD.

Specifically, during the second period, a third current Ipath3 flows to the first resonant capacitor CG1 based on turning on of the third coil switching device SW3 in the first group LG1, and the second current Ipath2 flows to the second resonant capacitor CG2 based on turning on of the second coil switching device SW2 in the second group LG2.

Alternatively, during the second period following the first period, the first current flows to the first resonant capacitor CG1 and the second current flows to the second resonant capacitor CG2, based on simultaneous turning on of the coil switching devices SW1 to SWD of other coils in the first group LG1 and the coil switching devices SW1 to SWD of other coils in the second group LG2 among the plurality of coils LA1 to LAD.

Specifically, during the second period, the third current Ipath3 flows to the first resonant capacitor CG1 based on turning on of the third coil switching device SW3 in the first group LG1, and a fourth current Ipath4 flows to the second resonant capacitor CG2 based on turning on of the fourth coil switching device SW4 in the second group LG2.

Meanwhile, the wireless power transfer apparatus 100 may further include the inverter 165 configured to perform a switching operation to supply power to at least one of the plurality of coils LA1 to LAD, and the controller 170 configured to control the inverter 165.

Meanwhile, as illustrated herein, the inverter 165 includes a first switching device Sa and a second switching device S′a, which are connected in series to each other, and a third switching device Sb and a fourth switching device S′b which are connected in series to each other and are connected in parallel to the first switching device Sa and the second switching device S′a, in which an operating voltage source Vdd may be connected to one end of the first switching device Sa and one end of the third switching device Sb, and a ground terminal GND may be connected to one end of the second switching device S′a and one end of the fourth switching device S′b, and a current detector E may be connected to another end of the second switching device S′a or another end of the fourth switching device S′b. Accordingly, based on the current flowing through the inverter 165, at least one coil may be selected from among the plurality of coils LA1 to LAD.

Meanwhile, during the first period, the controller 170 may operate some coils in the first group LG1 and some coils in the second group LG2 among the plurality of coils LA1 to LAD, and may receive, from the wireless power reception apparatus 200, first signal strength information in response to operation of the some coils in the first group LG1 and second signal strength information in response to operation of the some coils in the second group LG2.

Particularly, the controller 170 may receive, from the wireless power reception apparatus 200, the first signal strength information and the second signal strength information respectively through the first decoding line LD1, connected to the first resonant capacitor CG1, and the second decoding line LD2 connected to the second resonant capacitor CG2.

Then, during the second period following the first period, the controller 170 may operate other coils in the first group LG1 and some or other coils in the second group LG2 among the plurality of coils LA1 to LAD, and may receive, from the wireless power reception apparatus 200, third signal strength information and fourth signal strength information in response to operation of the other coils in the first group LG1 and the some or other coils in the second group KG2 through the first decoding line LD1 and the second decoding line LD2, respectively.

Based on the first to third pieces of signal strength information, the controller 170 may select at least one coil from among the plurality of coils LA1 to LAD and operate the selected at least one coil. In this manner, a coil selection period may be significantly reduced, compared to the case of selecting coils by individually driving the plurality of coils LA1 to LAD.

For example, if the controller 170 selects coils after individually driving each of the eight coils as illustrated in FIGS. 9A or FIG. 9B, it takes eight times to drive the coils, but according to the wireless power driver 160a of FIG. 10C, the eight coils are driven two at a time, such that it takes four times at minimum and six times at maximum.

The minimum four times correspond to the case where LA1 and LA2, LA3 and LA4, LAA and LAB, and LAC and LAD are driven in pairs, and the maximum six times correspond to the case where LA1 and LA2, LA2 and LA3, LA3 and LA4, LAA and LAB, LAB and LAC, and LAC and LAD are driven in pairs.

As a result, the present disclosure achieves the effect of reducing a coil selection period by minimum 25% to maximum 50%, compared to the case of individually driving each of the coils.

Meanwhile, while selecting coils from among the plurality of coils that are divided into the first group LG1 and the second group LG2, the controller 170 may select at least one coil corresponding to a position of the wireless power reception apparatus 200.

For example, the controller 170 may also select only one coil or two or more coils. Accordingly, it is possible to accurately select a coil corresponding to the position of the wireless power reception apparatus 200 and drive the selected coil, thereby improving wireless power transfer efficiency.

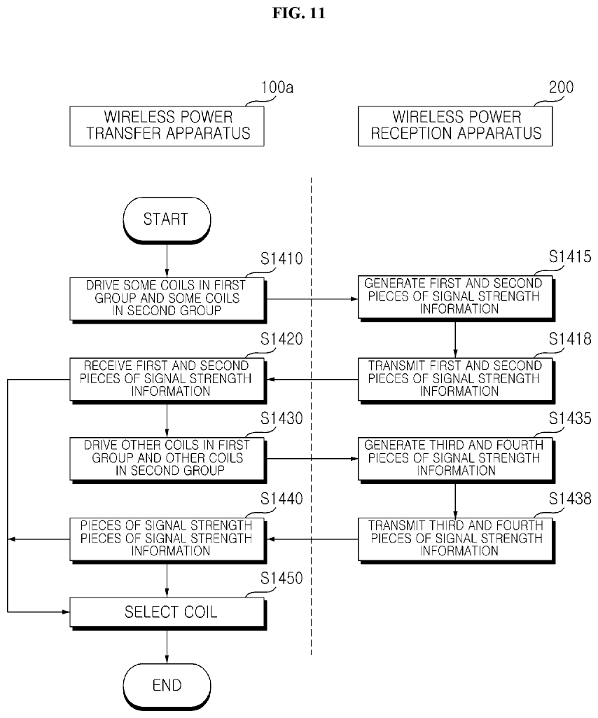

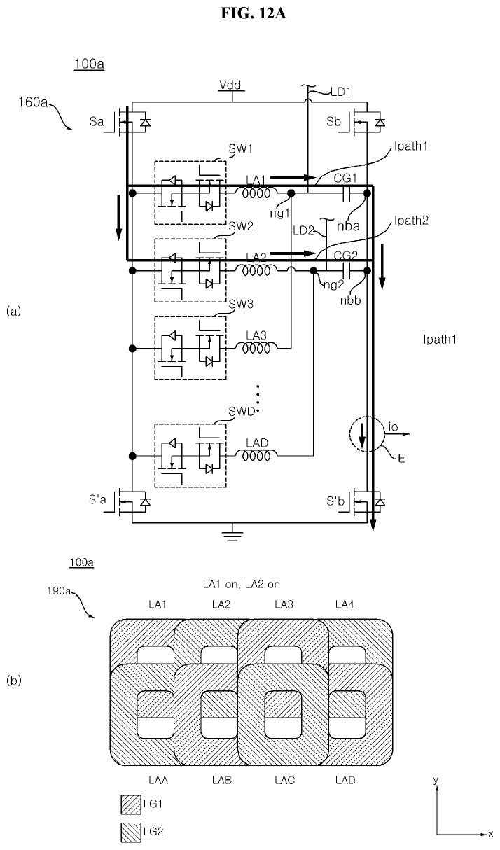

FIG. 11 is a flowchart illustrating an example of an operation method of the wireless power driver of FIG. 10C.

Referring to the drawing, the wireless power transfer apparatus 100a including the wireless power driver 160a of FIG. 10C drives some coils in the first group LG1 and some coils in the second group LG2 among the plurality of coils LA1 to LAD during a first period (S1410).

For example, the controller 170 may drive the first coil LA1 in the first group LG1 and the second coil LA2 in the second group LG21 during the first period.

To this end, each of the first coil switching device SW1 in the first group LG1 and the second coil switching device SW2 in the second group LG2 may be turned on during the first period.

Accordingly, power, transferred by driving the first coil LA1 of the first group LG1 and the second coil LA2 of the second group LG2, may be transferred o the wireless power reception apparatus 200.

The wireless power reception apparatus 200 detects a first signal strength in response to the driving of the first coil LA1 of the wireless power transfer apparatus 100a and generates first signal strength information, and detects a second signal strength in response to the driving of the second coil LA2 of the wireless power transfer apparatus 100a and generates second signal strength information (S1415).

Further, the wireless power reception apparatus 200 transmits the first signal strength information and the second signal strength information to the wireless power transfer apparatus 100a (S1418).

Accordingly, the wireless power transfer apparatus 100a receives the first signal strength information and the second signal strength information (S1420).

Then, the wireless power transfer apparatus 100a drives other coils in the first group LG1, and drives some coils or other coils in the second group LG2 among the plurality of coils LA1 to LAD during a second period (S1430).

For example, the controller 170 may drive each of the third coil LA3 in the first group LG1 and the fourth coil LA4 in the second group LG2 during the second period.

To this end, each of the third coil switching device SW3 in the first group LG1 and the fourth coil switching device SW4 in the second group LG2 may be turned on during the second period.

In another example, the controller 170 may drive each of the third coil LA3 in the first group LG1 and the second coil LA2 in the second group LG2 during the second period.

To this end, each of the third coil switching device SW3 in the first group LG1 and the second coil switching device SW2 in the second group LG2 may be turned on during the second period.

Meanwhile, wireless power, transferred by driving the third coil LA3 in the first group LG1 and the fourth coil LA4 in the second group LG2, may be transferred to the wireless power reception apparatus 200.

The wireless power reception apparatus 200 detects a third signal strength in response to the driving of the third coil LA3 of the wireless power transfer apparatus 100a and generates third signal strength information, and detects a fourth signal strength in response to the driving of the fourth coil LA4 of the wireless power transfer apparatus 100a and generates fourth signal strength information (S1435).

Further, the wireless power reception apparatus 200 transmit the third signal strength information and the fourth signal strength information to the wireless power transfer apparatus 100a (S1438).

Accordingly, the wireless power transfer apparatus 100a receives the third signal strength information and the fourth signal strength information (S1440).

Then, the controller 170 of the wireless power transfer apparatus 100a selects at least one coil from among the plurality of coils LA1 to LAD based on the first to fourth pieces of signal strength information (S1450).

For example, the controller 170 may also select only one coil or two or more coils. Accordingly, it is possible to accurately select a coil corresponding to the position of the wireless power reception apparatus 200 and drive the selected coil, thereby improving wireless power transfer efficiency.

Meanwhile, according to the method of FIG. 11 in comparison with FIG. 8B, instead of sequentially driving the eight coils eight times, it is sufficient to drive the eight coils four times in total by sequentially driving two coils at a time, such that a coil selection period may be reduced by approximately 50%.

In addition, by using only the resonant capacitors CG1 and CG2 corresponding to the number of groups of coils, the wireless power transfer apparatus 100a may be reduced in size while simply implementing a circuit. In addition, by driving the plurality of coils, a plurality of wireless power reception apparatuses 200 may be charged wirelessly.

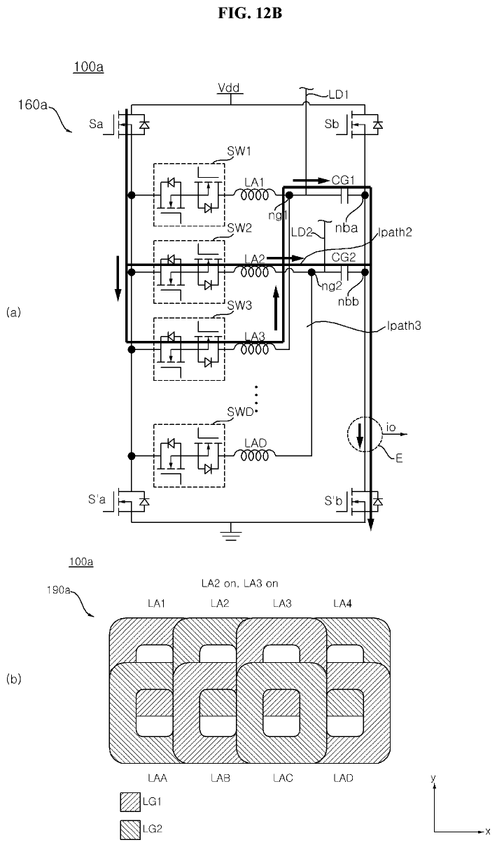

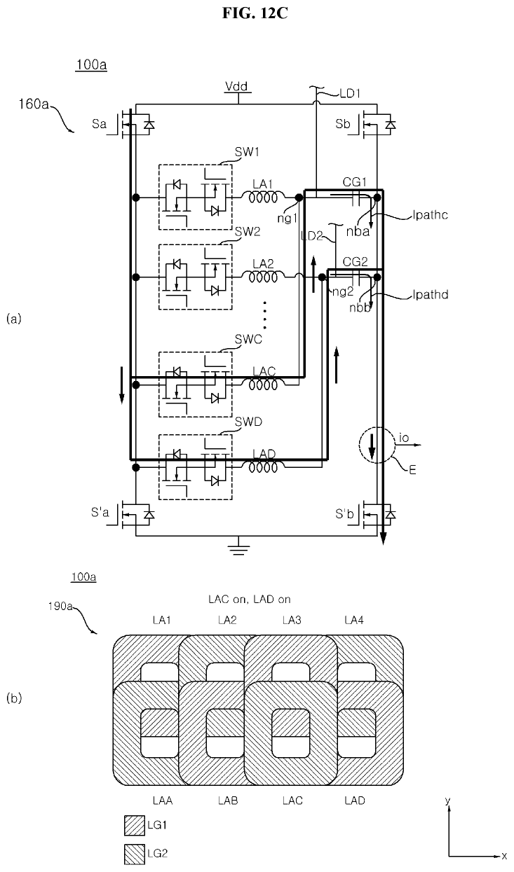

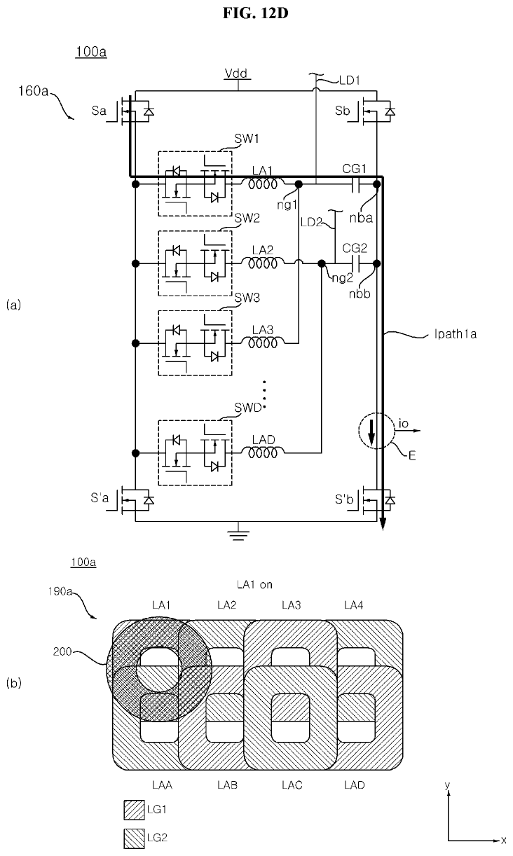

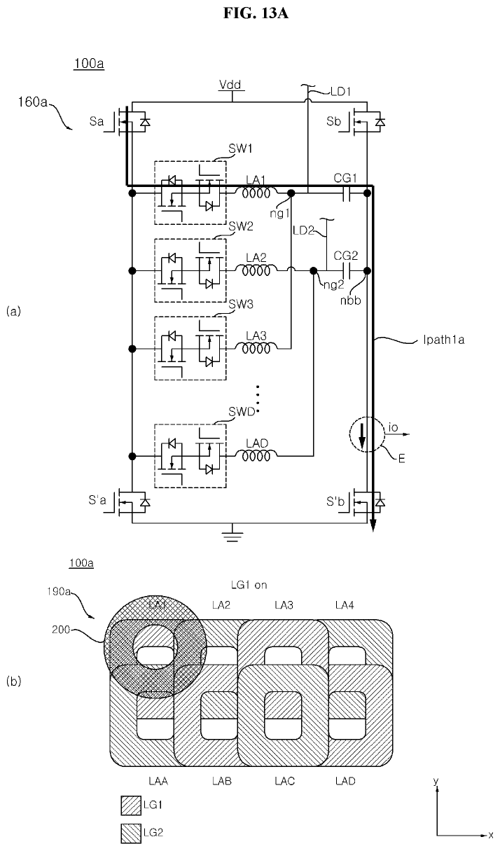

FIGS. 12A to 14B are diagrams referred to in the description of operation of FIG. 11.

Referring to the drawings, (a) of FIG. 12A illustrates an example in which the first coil LA1 in the first group LG1 and the second coil LA2 in the second group LG2 are driven respectively during a first period.

To this end, the first coil switching device SW1 in the first group LG1 and the second coil switching device SW2 in the second group LG2 are turned on respectively during the first period.

Accordingly, the first current Ipathl flows through the first switching device Sa of the inverter 165, the first coil switching device SW1, the first coil LA1, the first resonant capacitor CG1, and the fourth switching device S′b of the inverter 165; and the second current Ipath2 flows through the first switching device Sa of the inverter 165, the second coil switching device SW2, the second coil LA2, the second resonant capacitor CG2, and the fourth switching device S′b of the inverter 165.

Accordingly, wireless power, transferred by driving the first coil LA1 in the first group LG1 and the second coil LA2 in the second group LG2, is transferred to the wireless power reception apparatus 200.

Meanwhile, the controller 170 may receive, from the wireless power reception apparatus 200, first signal strength information and second signal strength information respectively through the first decoding line LD1 connected to the first resonant capacitor CG1 and the second decoding line LD2 connected to the second resonant capacitor CG2.

In FIG. 12B, (a) illustrates an example in which the third coil LA3 in the first group LG1 and the second coil LA2 in the second group LG2 are individually driven during a second period.

To this end, the third coil switching device SW3 in the first group LG1 and the second coil switching device SW2 in the second group LG2 are individually turned on during the second period.

Accordingly, the third current Ipath3 flows through the first switching device Sa of the inverter 165, the third coil switching device SW3, the third coil LA3, the first resonant capacitor CG1, and the fourth switching device S′b of the inverter 165; and the second current Ipath2 flows through the first switching device Sa of the inverter 165, the second coil switching device SW2, the second coil LA2, the second resonant capacitor CG2, and the fourth switching device S′b of the inverter 165.

Accordingly, wireless power, transferred by driving the third coil LA3 in the first group LG1 and the second coil LA2 in the second group LG2, is transferred to the wireless power reception apparatus 200.

Meanwhile, the controller 170 may receive third signal strength information and the second signal strength information from the wireless power reception apparatus 200 respectively through the first decoding line LD1 connected to the first resonant capacitor CG1 and the second decoding line LD2 connected to the second resonant capacitor CG2.

Meanwhile, unlike FIG. 12B, it is also possible that the third coil switching device SW3 in the first group LG1 and the fourth coil switching device SW4 in the second group LG2 may be individually turned on during the second period.

Accordingly, the controller 170 may receive the third signal strength information and the fourth signal strength information from the wireless power reception apparatus 200 respectively through the first decoding line LD1 connected to the first resonant capacitor CG1 and the second decoding line LD2 connected to the second resonant capacitor CG2.

In FIG. 12C, (a) illustrates an example in which a seventh coil LAC in the first group LG1 and an eighth coil LAD in the second group LG2 are individually driven during a sixth period.

To this end, a seventh coil switching device SWC in the first group LG1 and an eighth coil switching device SWD in the second group LG2 are individually turned on during the sixth period.

Accordingly, a seventh current Ipathc flows through the first switching device Sa of the inverter 165, the seventh coil switching device SWC, the seventh coil LAC, the first resonant capacitor CG1, and the fourth switching device S′b of the inverter 165; and an eighth current Ipathd flows through the first switching device Sa of the inverter 165, the eighth coil switching device SWD, the eighth coil LAD, the second resonant capacitor CG2, and the fourth switching device S′b of the inverter 165.

Accordingly, wireless power, transferred by driving the seventh coil LAC in the first group LG1 and the eighth coil LAD in the second group LG2, is transferred to the wireless power reception apparatus 200.

Meanwhile, the controller 170 may receive seventh signal strength information and eighth signal strength information from the wireless power reception apparatus 200 respectively through the first decoding line LD1 connected to the first resonant capacitor CG1 and the second decoding line LD2 connected to the second resonant capacitor CG2.

Meanwhile, the controller 170 may select at least one coil from among the plurality of coils LA1 to LAD based on the received first to eighth signal strength information, and may drive the selected at least one coil. In this manner, a coil selection period may be significantly reduced, compared to the case of selecting coils by individually driving the plurality of coils LA1 to LAD.

In FIG. 12D, (a) illustrates an example in which a position of the wireless power reception apparatus 200 corresponds to the first coil LA1, such that only the first coil LA1 in the first group LA1 is driven.

If the position of the wireless power reception apparatus 200 corresponds to the first coil LA1, the coil switching device SW1 corresponding to the first coil LA1 is turned on, and a current Ipath1a flows through the first switching device Sa of the inverter 165, the first coil switching device SW1, the first coil LA1, the first resonant capacitor CG1, and the fourth switching device S′b of the inverter 165.

Accordingly, as illustrated in (b) of FIG. 12D, only the first coil LA1 included in the first group LG1 operates, and wireless power, transferred by driving the first coil LA1, is transferred to the wireless power reception apparatus 200.

Meanwhile, if wireless power transfer at a level less than or equal to a first reference value is required, the controller 170 may drive only one coil selected from the first group LG1 and the second group LG2, and if wireless power transfer at a level greater than the first reference value is required, the controller 170 may drive two coils selected from the first group LG1 and the second group LG2 and greater in number than one coil which is at least some in the groups. Accordingly, the number of coils may varys depending on power required for wireless power transfer.

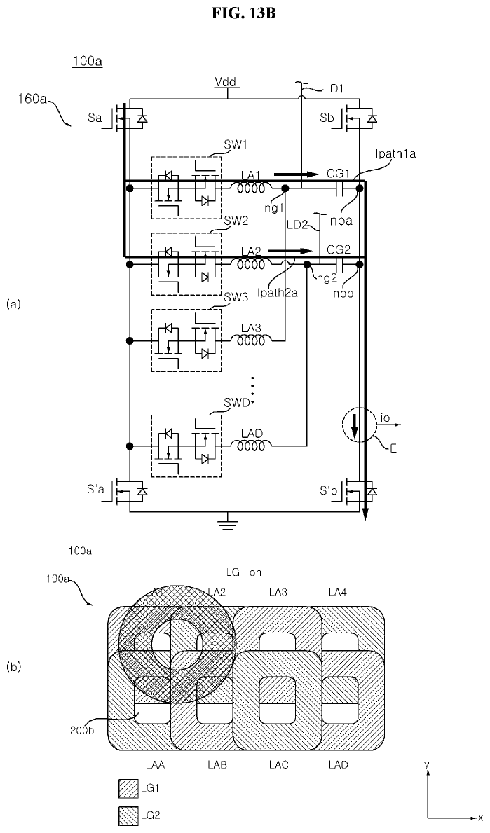

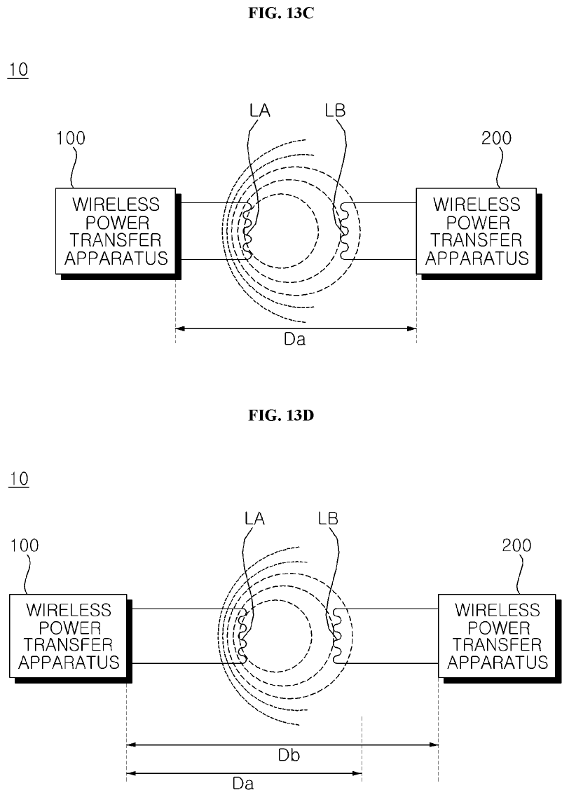

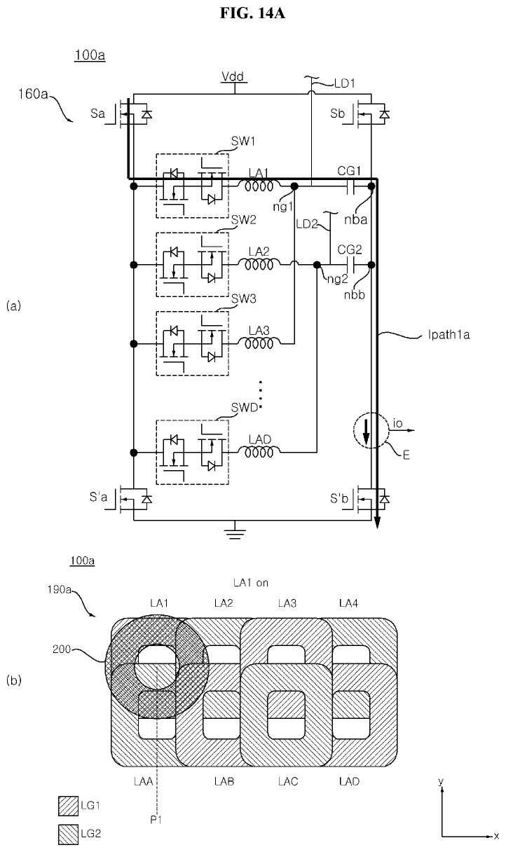

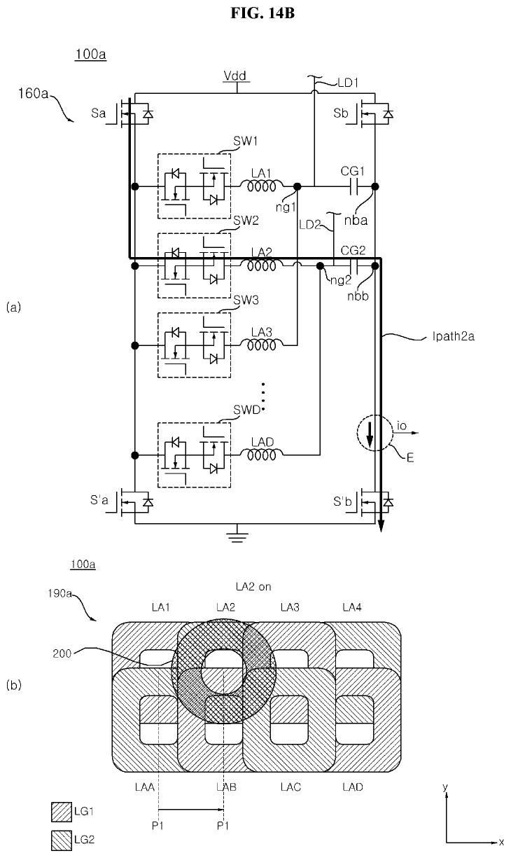

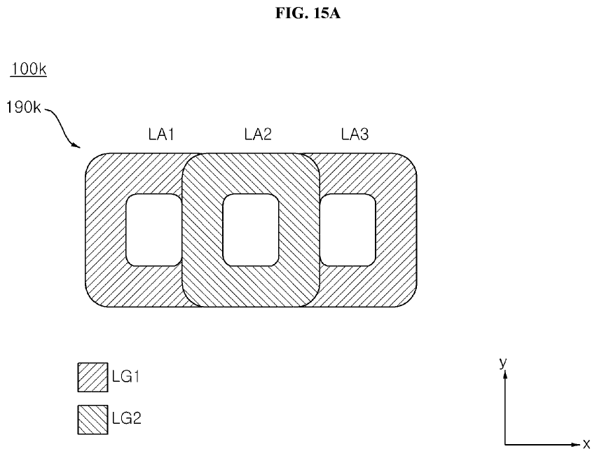

FIG. 13A is a diagram illustrating an example of operating only the first coil LA1 as illustrated in FIG. 12D.

Referring to the drawing, if a position of the wireless power reception apparatus 200 of a first size corresponds to a position of the first coil LA1, the controller 170 may drive only the first coil LA1 in the first group LG1.

Then, FIG. 13B is a diagram illustrating an example in which if a position of a second wireless power reception apparatus 200b of a second size, which is greater than the first size, corresponds to positions of the first coil LA1 and the second coil LA2, the controller 170 may drive the first coil LA1 and the second coil LA2.

To this end, based on signal strength information received from the wireless power reception apparatus 200, the controller 170 may operate only the first coil LA1 in the first group LG1 and the second coil LA2 in the second group LG2.

Meanwhile, in addition to the signal strength information from the second wireless power reception apparatus 200b, the controller 170 may further receive required power information.

Meanwhile, if wireless power transfer at a level less than or equal to the first reference value is required, the controller 170 may drive only one coil selected from the first group LG1 and the second group LG2, and if wireless power transfer at a level greater than the first reference value is required, the controller 170 may drive two coils selected from the first group LG1 and the second group LG2 and greater in number than one coil which is at least some in the groups. Accordingly, the number of operating groups or operating coils may change depending on power required for wireless power transfer.

Meanwhile, in response to receiving first required power information at a level less than or equal to a first reference value from the wireless power reception apparatus 200, the controller 170 may drive one coil as illustrated in FIG. 13A, and in response to receiving second required power information at a level greater than the first reference value from the second wireless power reception apparatus 200b, the controller 170 may drive two coils as illustrated in FIG. 13B. Accordingly, the number of operating coils may change depending on power required for wireless power transfer.

Meanwhile, if the wireless power transfer apparatus 100 is spaced apart from the wireless power reception apparatus 200 by a first distance Da, the controller 170 may drive only one coil selected from the first group LG1 and the second group LG2, and if the wireless power transfer apparatus 100 is spaced apart from the wireless power reception apparatus 200 by a second distance Db which is larger than the first distance Da, the controller 170 may drive two coils selected from the first group LG1 and the second group LG2 and greater in number than one coil which is at least some in the groups.

FIG. 13C is a diagram illustrating an example in which the wireless power transfer apparatus 100 and the wireless power reception apparatus 200 are spaced apart from each other by the first distance Da, and FIG. 13D is a diagram illustrating an example in which the wireless power transfer apparatus 100 and the wireless power reception apparatus 200 are spaced apart from each other by the second distance Db.

Referring to FIG. 13C, if the wireless power transfer apparatus 100 and the wireless power reception apparatus 200 are spaced apart from each other by the first distance Da, the controller 170 may receive signal strength information or first required power information from the wireless power reception apparatus 200, and based on the received signal strength information or first required power information, the controller 170 may drive one coil as illustrated in FIG. 13A.

Referring to FIG. 13D, if the wireless power transfer apparatus 100 and the wireless power reception apparatus 200 are spaced apart from each other by the second distance Db which is larger than the first distance D1, the controller 170 may receive signal strength information or second required power information from the wireless power reception apparatus 200, and based on the received signal strength information or second required power information, the controller 170 may drive two coils as illustrated in FIG. 13B. Accordingly, the number of operating coils may change depending on power required for wireless power transfer.

Meanwhile, while only at least some coils in the first group LG1 are driven as illustrated in FIG. 13A, if the wireless power reception apparatus 200 moves as illustrated in FIG. 13B, the controller 170 may operate at least some coils in the first group LG1 and at least some coils in the second group LG2. Accordingly, the number of operating coils may change in response to movement of the wireless power reception apparatus 200.

Meanwhile, if the wireless power reception apparatus 200 moves while only at least some coils in the first group LG1 are driven, the controller 170 may operate only some coils in the second group LG2. Accordingly, the number of operating coils may change in response to movement of the wireless power reception apparatus 200, which will be described below with reference to FIGS. 14A and 14B.

FIG. 14A is a diagram illustrating an example of operating only the first coil LA1 in the first group LG1 as illustrated in FIG. 12D.

Referring to the drawing, if a position of the wireless power reception apparatus 200 is P1 corresponding to a position of the first coil LA1, the controller 170 may drive only the first coil LA1 in the first group LG1.

Next, FIG. 14B is a diagram illustrating an example of operating only the second coil LA2 in the second group LG2.

Referring to the drawing, if the wireless power reception apparatus 200 moves from P1, corresponding to the position of the first coil LA1, to P2 corresponding to a position of the second coil LA2, the controller 170 may drive only the second coil LA2 in the second group LG2.

For example, while driving only the first coil LA1, if the controller 170 receives updated signal strength information in response to movement of the wireless power reception apparatus 200, the controller 170 may select only the second coil LA2 in the second group LG2 based on the updated signal strength information, and may operate the selected second coil LA2. Accordingly, the operating coil may change in response to movement of the wireless power reception apparatus 200.

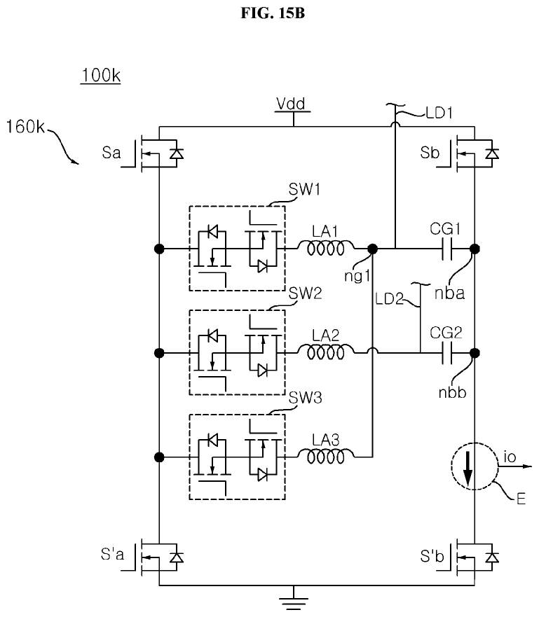

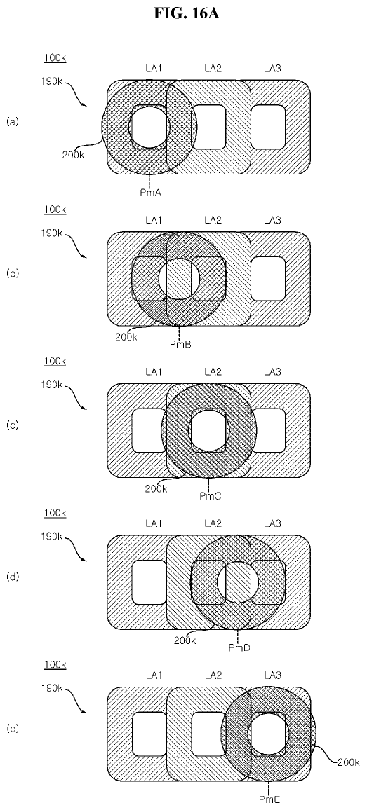

FIG. 15A is a diagram illustrating an example of a coil assembly according to another embodiment of the present disclosure.

Referring to the drawing, a coil assembly 190k according to another embodiment of the present disclosure may include a plurality of coils LA1 to LA3. Particularly, the coil assembly 190k may include three coils LA1 to LA3.

In the drawing, an example is illustrated in which the plurality of coils LA1 to LA3 are arranged in a first row while partially overlapping each other.

Meanwhile, in the embodiment of the present disclosure, the plurality of coils LA1 to LA3 are divided into groups in order to simply implement a circuit for selecting and operating at least some of the plurality of coils LA1 to LA3.

Particularly, the plurality of coils are grouped so that the number of groups of the plurality of coils LA1 to LA3 is smaller than the number of the plurality of coils LA1 to LA3.

For example, among the plurality of coils LA1 to LA3, the first coil LA1 and a coil not adjacent to the first coil LA1 may be included in the first group LG1, and the second coil LA2 adjacent to the first coil LA1 may be included in a second group LG2.

Specifically, it is illustrated in the drawing that, among the plurality of coils LA1 to LA3, the first coil LA1 and the third coil LA3 are included in the first group LG1, and the second coil LA2 is included in the second group LG2.

FIG. 15B is a diagram illustrating an example of a wireless power transfer apparatus including a wireless power driver corresponding to the coil assembly of FIG. 15A.

Referring to the drawing, a wireless power driver 160k in a wireless power transfer apparatus 100k according to another embodiment of the present disclosure includes: a coil assembly 190k including a plurality of coils LA1 to LA3; a first resonant capacitor CG1 connected to a first group LG1 among the plurality of coils LA1 to LA3; and a second resonant capacitor CG2 connected to a second group LG2 among the plurality of coils LA1 to LA3 and connected in parallel to the first resonant capacitor CG1.

Accordingly, it is possible to simply implement a circuit for selecting and operating at least some of the plurality of coils LA1 to LA3. Further, by using only the resonant capacitors CG1 and CG2 corresponding to the number of groups, the wireless power transfer apparatus 100 may be reduced in size while simply implementing the circuit.

Meanwhile, the wireless power transfer apparatus 100k according to another embodiment of the present disclosure may further include coil switching devices SW1 to SW3 which are connected to the plurality of coils LA1 to LA3, respectively.

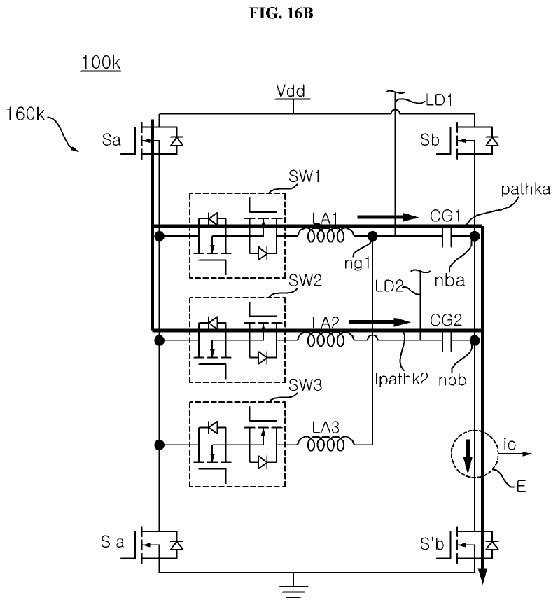

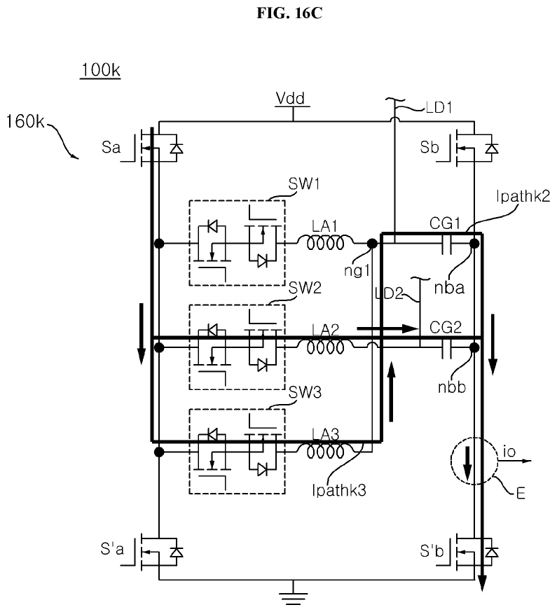

Meanwhile, while selecting coils from among the plurality of coils that are divided into the first group LG1 and the second group LG2, the controller 170 may select at least one coil corresponding to a position of a wireless power reception apparatus 200k, which will be described below with reference to FIG. 16A.

FIG. 16A is a diagram illustrating movement of the wireless power reception apparatus 200k corresponding to the coil assembly 190k of FIG. 15A.

Referring to the drawing, (a) of FIG. 16A illustrates an example in which a position of the wireless power reception apparatus 200k is PmA which corresponds to the first coil LA1.

Meanwhile, (b) of FIG. 16A illustrates an example in which a position of the wireless power reception apparatus 200k is PmB which corresponds to the first coil LA1 and the second coil LA2; (c) of FIG. 16A illustrates an example in which a position of the wireless power reception apparatus 200k is PmC which corresponds to the second coil LA2; (d) of FIG. 16A illustrates an example in which a position of the wireless power reception apparatus 200k is PmD which corresponds to the second coil LA2 and the third coil LA3; and (e) of FIG. 16A illustrates an example in which a position of the wireless power reception apparatus 200k is PmE which corresponds to the second coil LA2.

As illustrated in FIG. 16A, the wireless power reception apparatus 200k may be disposed at various positions.

In this embodiment of the present disclosure, the plurality of coils are divided into groups, and a plurality of coils are driven simultaneously by driving one coil per group, and then at least one coil corresponding to the position of the wireless power reception apparatus 200k is driven based on signal strength information received from the wireless power reception apparatus 200k.

FIG. 16B is a diagram illustrating an example in which the first coil LA1 in the first group LG1 and the second coil LA2 in the second group LG2 are driven during a first period.

Referring to the drawing, during the first period, a first current Ipathk1 flows to the first resonant capacitor CG1 based on turning on of the first coil switching device SW1 in the first group LG1, and a second current Ipathk2 flows to the second resonant capacitor CG2 based on turning on of the second coil switching device SW2 in the second group LG2.

FIG. 16C is a diagram illustrating an example in which the third coil LA3 in the first group LG1 and the second coil LA2 in the second group LG2 are driven during a second period.

Referring to the drawing, during the second period following the first period, a third current Ipathk3 flows to the first resonant capacitor CG1 based on turning on of the third coil switching device SW3 in the first group LG1, and the second current Ipathk2 flows to the second resonant capacitor CG2 based on turning on of the second coil switching device SW2 in the second group LG2.

Meanwhile, the controller 170 may operate some coils in the first group LG1 and some coils in the second group LG2 during the first period among the plurality of coils LA1 to LA3, and may receive, from the wireless power reception apparatus 200k, first signal strength information in response to the operation of the some coils in the first group LG1 and second signal strength information in response to the operation of the some coils in the second group LG2.

Particularly, the controller 170 may receive, from the wireless power reception apparatus 200, the first signal strength information and the second signal strength information respectively through the first decoding line LD1 connected to the first resonant capacitor CG1 and the second decoding line LD2 connected to the second resonant capacitor CG2.

Then, during the second period following the first period, the controller 170 may operate other coils in the first group LG1 and some coils in the second group LG2 among the plurality of coils LA1 to LAD, and may receive third signal strength information and fourth signal strength information from the wireless power reception apparatus 200k in response to the operation of the other coils in the first group LG1 and the operation of the some coils in the second group LG2 through the first decoding line LD1 and the second decoding line LD2.

Based on the first to third pieces of signal strength information, the controller 170 may select at least one coil from among the plurality of coils LA1 to LA3 and operate the selected at least one coil. Accordingly, by selectively driving the plurality of coils LA1 to LA3 by group, a coil selection period may be significantly reduced, compared to the case of selecting coils by individually driving the plurality of coils LA1 to LA3.

For example, in the case of selecting coils after individually driving three coils, it takes three times to drive the coils, but according to the wireless power driver 160k of FIG. 15B, three coils are driven two at a time, such that it takes two times to drive the coils.

As a result, according to the wireless power driver 160k of FIG. 15B, the effect of reducing a coil selection period by 50% is produced, compared to the case of individually driving the coils.

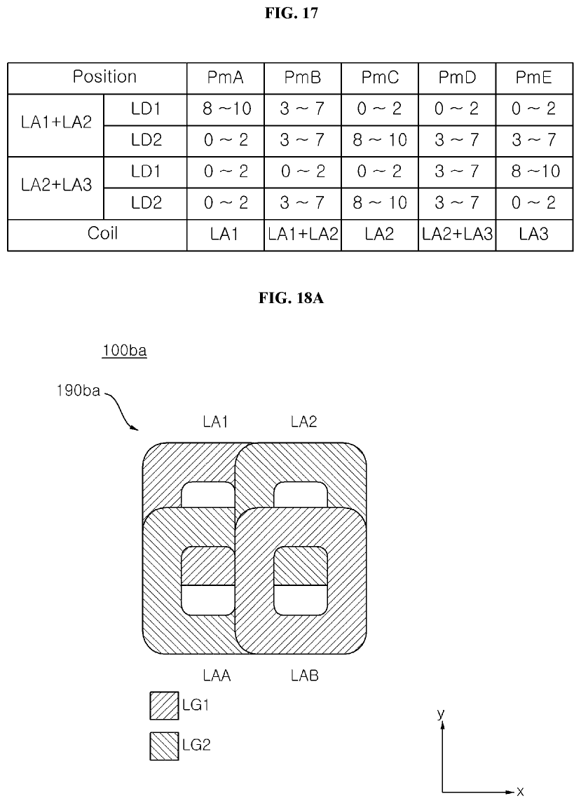

FIG. 17 is a diagram illustrating an example of signal strength information depending on a position of the wireless power reception apparatus 200k of FIG. 16A.

Referring to the drawing, the first coil and the second coil LA1+LA2 are driven during a first period, and the second coil and the third coil LA2+LA3 are driven during a second period.

Meanwhile, if a position of the wireless power reception apparatus 200k is PmA, the first signal strength information received through the first decoding line LD1 during the first period may be at a level of approximately 9 to 10 and the second signal strength information received through the second decoding line LD2 during the first period may be at a level of approximately 0 to 2, and third signal strength information received through the first decoding line LD1 during the second period may be at a level of approximately 0 to 2 and fourth signal strength information received through the second decoding line LD2 during the second period may be at a level of approximately 0 to 2.

Accordingly, as the first signal strength information is at a highest level among the first to fourth pieces of signal strength information, the controller 170 may select and operate the first coil LA1.

Then, if a position of the wireless power reception apparatus 200k is PmB, the first signal strength information received through the first decoding line LD1 during the first period may be at a level of approximately 3 to 7 and the second signal strength information received through the second decoding line LD2 during the first period may be at a level of approximately 3 to 7, and third signal strength information received through the first decoding line LD1 during the second period may be at a level of approximately 0 to 2 and fourth signal strength information received through the second decoding line LD2 during the second period may be at a level of approximately 3 to 7.

Accordingly, the levels of the first signal strength information, the third signal strength information, and the fourth signal strength information are greater than the level of the second signal strength information among the first to fourth pieces of signal strength information, such that the controller 170 may select the first coil LA1 and the second coil LA2 and operate the two coils.

Then, if a position of the wireless power reception apparatus 200k is PmC, the first signal strength information received through the first decoding line LD1 during the first period may be at a level of approximately 0 to 2 and the second signal strength information received through the second decoding line LD2 during the first period may be at a level of approximately 8 to 10, and third signal strength information received through the first decoding line LD1 during the second period may be at a level of approximately 0 to 2 and fourth signal strength information received through the second decoding line LD2 during the second period may be at a level of approximately 8 to 10.

Accordingly, the levels of the second signal strength information and the fourth signal strength information are greater than the levels of the first signal strength information and the third signal strength information among the first to fourth pieces of signal strength information, such that the controller 170 may select and operate the second coil LA2.

Next, if a position of the wireless power reception apparatus 200k is PmD, the first signal strength information received through the first decoding line LD1 during the first period may be at a level of approximately 0 to 2 and the second signal strength information received through the second decoding line LD2 during the first period may be at a level of approximately 3 to 7, and third signal strength information received through the first decoding line LD1 during the second period may be at a level of approximately 3 to 7, and fourth signal strength information received through the second decoding line LD2 during the second period may be at a level of approximately 3 to 7.

Accordingly, the levels of the second signal strength information, the third signal strength information, and the fourth signal strength information are greater than the level of the first signal strength information among the first to fourth pieces of signal strength information, such that the controller 170 may select the second coil LA2 and the third coil LA1 and operate the two coils.

Then, if a position of the wireless power reception apparatus 200k is PmE, the first signal strength information received through the first decoding line LD1 during the first period may be at a level of approximately 0 to 2 and the second signal strength information received through the second decoding line LD2 during the first period may be at a level of approximately 3 to 7, and third signal strength information received through the first decoding line LD1 during the second period may be at a level of approximately 8 to 10, and fourth signal strength information received through the second decoding line LD2 during the second period may be at a level of approximately 0 to 2.

Accordingly, as the third signal strength information is at a highest level among the first to fourth pieces of signal strength information, the controller 170 may select and operate the second coil LA2.

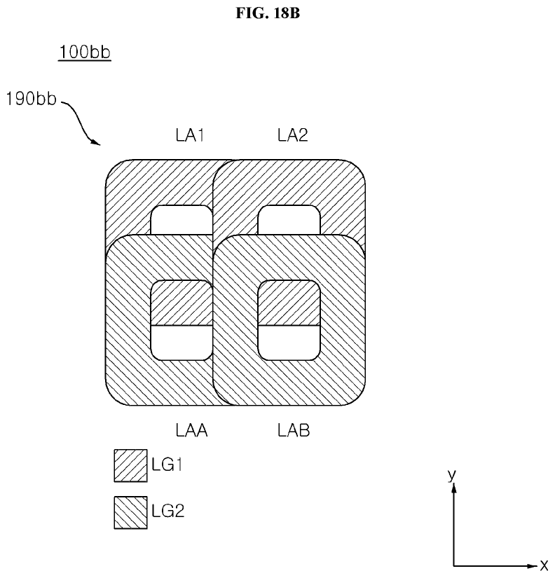

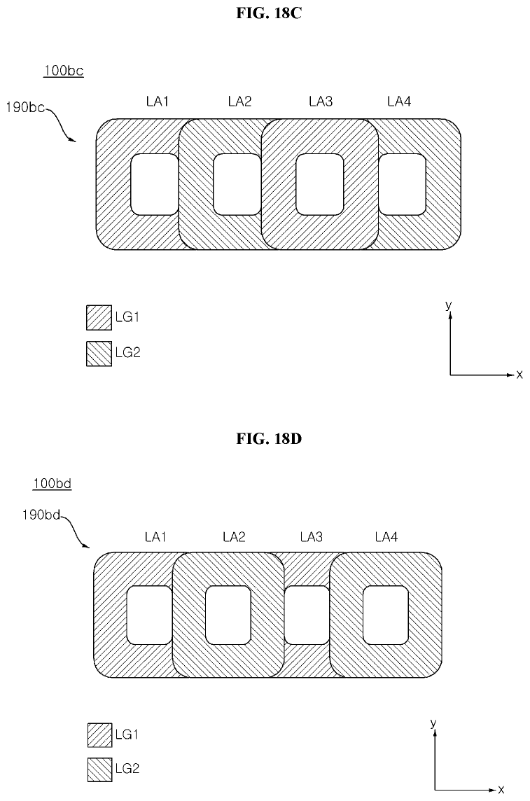

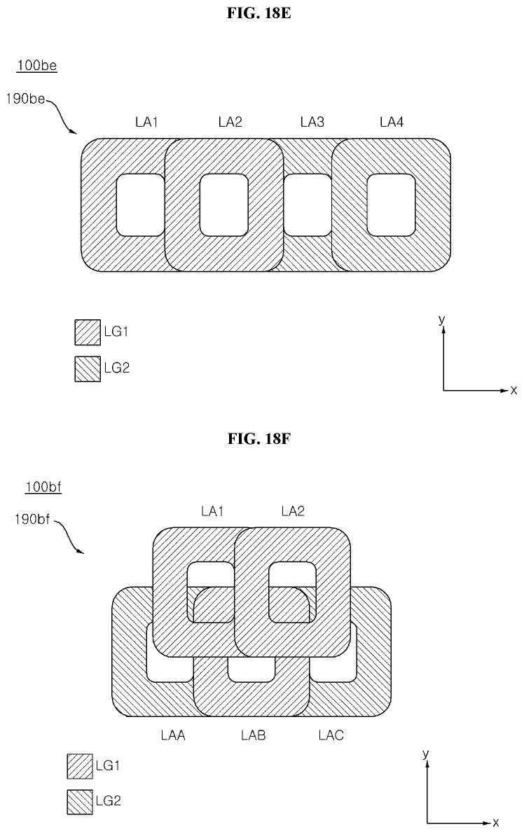

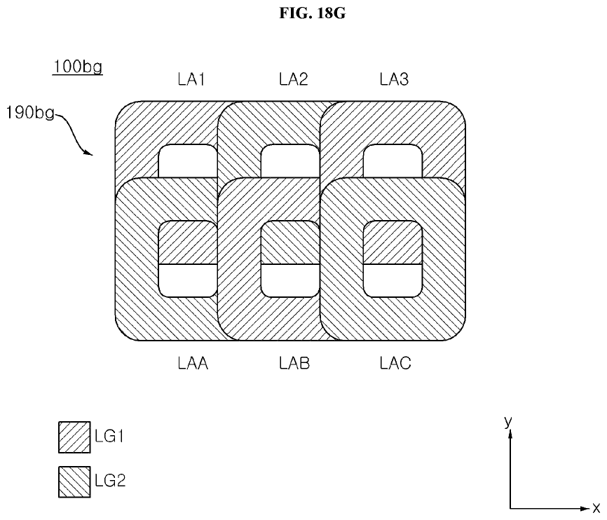

FIGS. 18A to 18G are diagrams illustrating examples of a coil array of various shapes or groups.

First, FIG. 18A is a diagram illustrating a coil array 190ba including coils LA1, LA2, LAA, and LAB in 2X2 form.

According to the coil array 190ba in a wireless power transfer apparatus 100ba, the first coil LA1 and the second coil LA2 adjacent to the first coil LA1 in a first direction (x-axis direction) and a second direction (y-axis direction or −y axis direction) may be included in the first group LG1 among the plurality of coils LA1 to LAB; and the third coil LAA adjacent to the first coil LA1 in the second direction (y-axis direction or −y axis direction) and the fourth coil LA2 not adjacent to the third coil LAA in the first direction (x-axis direction) and the second direction (y-axis direction or −y axis direction) may be included in the second group LG2. Accordingly, by grouping the coils not adjacent to each other, a wider area may be covered during wireless power transfer.

Then, FIG. 18B is a diagram illustrating a coil array 190bb including coils LA1, LA2, LAA, and LAB in 2×2 form.

According to the coil array 190bb in a wireless power transfer apparatus 100bb, the first coil LA1 and the second coil LA2 adjacent to the first coil LA1 in the first direction (x-axis direction) may be included in the first group LG1 among the plurality of coils LA1 to LAB; and the third coil LAA adjacent to the first coil LA1 in the second direction (y-axis direction or −y axis direction) and the fourth coil LAB adjacent to the third coil LAA in the first direction (x-axis direction) may be included in the second group LG2. Accordingly, the coils may be grouped in various shapes, and a circuit for selecting and operating at least some of the plurality of coils LA1 to LAD may be simply implemented by the grouping.

Next, FIG. 18C is a diagram illustrating a coil array 190bc including coils LA1, LA2, LA3, and LA4 in 1×4 form.

According to the coil array 190bc in the wireless power transfer apparatus 100bc, the plurality of coils LA1 to LA4 are sequentially arranged in the first direction (x-axis direction), and the first coil LA1 and the third coil LA3 may be included in the first group LG1 among the plurality of coils LA1 to LA4, and the second coil LA2 and the fourth coil LA4 may be included in the second group LG2 among the plurality of coils LA1 to LA4. Accordingly, the coils may be grouped in various shapes, and a circuit for selecting and operating at least some of the plurality of coils LA1 to LA4 may be simply implemented by the grouping.

Then, FIG. 18D is a diagram illustrating a coil array 190bd including coils LA1, LA2, LA3, and LA4 in 1×4 form, similarly to FIG. 18C.

According to the coil array 190bd in the wireless power transfer apparatus 100bd, the plurality of coils LA1 to LA4 are sequentially arranged in the first direction (x-axis direction), and the first coil LA1 and the third coil LA3 may be included in the first group LG1 among the first to fourth coils LA1 to LA4, and the second coil LA2 and the fourth coil LA4 may be included in the second group LG2 among the first to fourth coils LA1 to LA4. Accordingly, the coils may be grouped in various shapes, and a circuit for selecting and operating at least some of the plurality of coils LA1 to LA4 may be simply implemented by the grouping.

While FIG. 18C illustrates an example in which the coils are arranged in the order of LA1, LA2, and LA3 in a direction from the bottom to the top (z-axis direction), and the height of LA4 is approximately equal to LA2, FIG. 18D illustrates an example in which LA1 and LA2 are arranged in the direction from the bottom to the top (z-axis direction), and LA3 is disposed below LA2, and LA4 is disposed above LA3.

That is, in FIG. 18D, LA1 and LA3 are arranged approximately at the same height, and LA2 and LA4 are arranged approximately at the same height.

Next, FIG. 18E illustrates a coil array 190be including coils LA1, LA2, LA3, and LA4 in 1×4 form, similarly to FIG. 18D. In this case, similarly to FIG. 18D, LA1 and LA3 are arranged approximately at the same height, and LA2 and LA4 are arranged approximately at the same height.

According to the coil array 190be in the wireless power transfer apparatus 100be, the first coil LA1 and the second coil LA2 adjacent to the first coil LA1 in the first direction (x-axis direction) may be included in the first group LG1 among the plurality of coils LA1 to LA4, and the third coil LA3 adjacent to the second coil LA2 and the fourth coil LA4 adjacent to the third coil LA3 in the first direction (x-axis direction) may be included in the second group LG2 among the plurality of coils LA1 to LA4. Accordingly, the coils may be grouped in various shapes, and a circuit for selecting and operating at least some of the plurality of coils LA1 to LA4 may be simply implemented by the grouping.

Then, FIG. 18F is a diagram illustrating a coil array 190bf including five coils LA1, LA2, LAA, LAB, and LAC.

According to the coil array 190bf in the wireless power transfer apparatus 100bf, two coils LA1 and LA2 are arranged in a first row, and three coils LAA, LAB, and LAC are arranged in a downward direction (−y axis direction) in a second row below the first row.

Among the five coils, the coils LA1, LA2, and LAB adjacent to each other may be included in the first group LG1, and the coils LAA are LAB which are spaced apart from each other may be included in the second group LG2. Accordingly, the coils may be grouped in various shapes, and a circuit for selecting and operating at least some of the plurality of coils LA1 to LAC may be simply implemented by the grouping.

FIG. 18G is a diagram illustrating a coil array 190ba including LA1, LA2, LA3, LAA, LAB, and LAC.

According to the coil array 190bg in the wireless power transfer apparatus 100bg, the first coil LA1 and the second coil LA2 adjacent to the first coil LA1 in the first direction (x-axis direction) and the second direction (y-axis direction or −y axis direction) and the third coil not adjacent to the second coil LAB in the first direction (x-axis direction) and the second direction (y-axis direction or −y axis direction) may be included in the first group LG1 among the plurality of coils LA1 to LAC, and the fourth coil LAA adjacent to the first coil LA1 in the second direction (y-axis direction or −y axis direction), the fifth coil LA2 not adjacent to the fourth coil LAA in the first direction (x-axis direction) and the second direction (y-axis direction or −y axis direction), and the sixth coil LAC not adjacent to the fifth coil LA2 in the first direction (x-axis direction) and the second direction (y-axis direction or −y axis direction) may be included in the second group LG2 among the plurality of coils LA1 to LAC. Accordingly, by grouping the coils not adjacent to each other, a wider area may be covered during wireless power transfer.

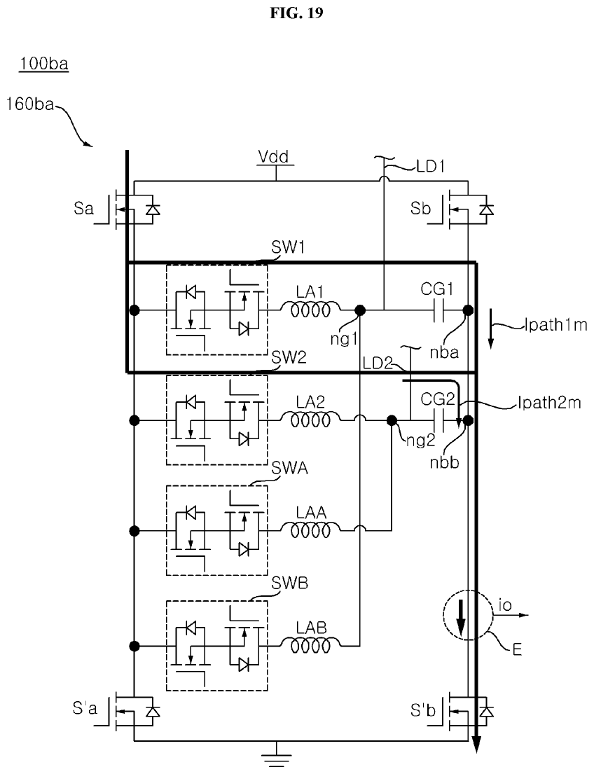

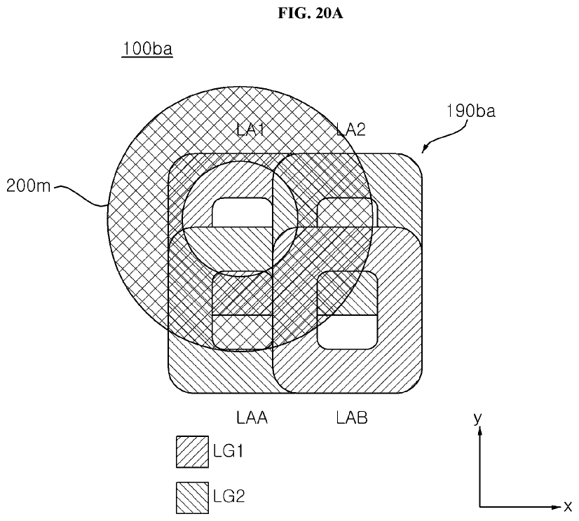

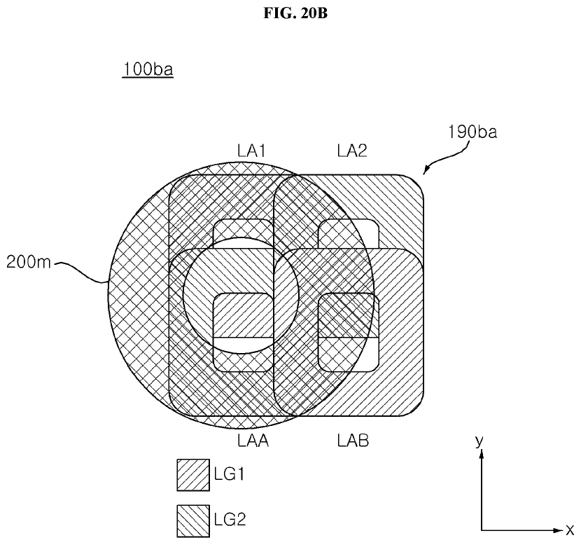

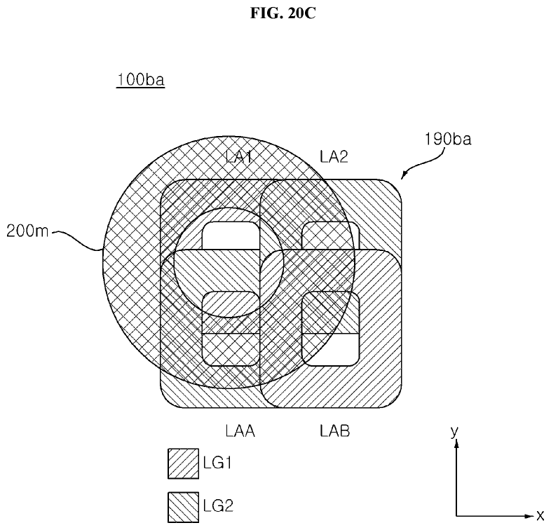

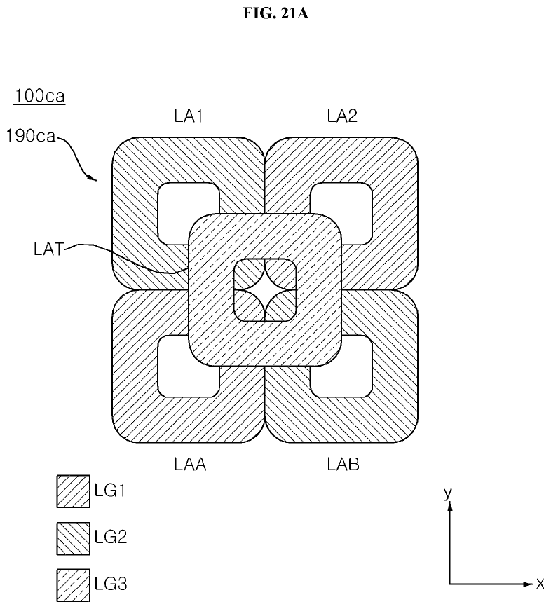

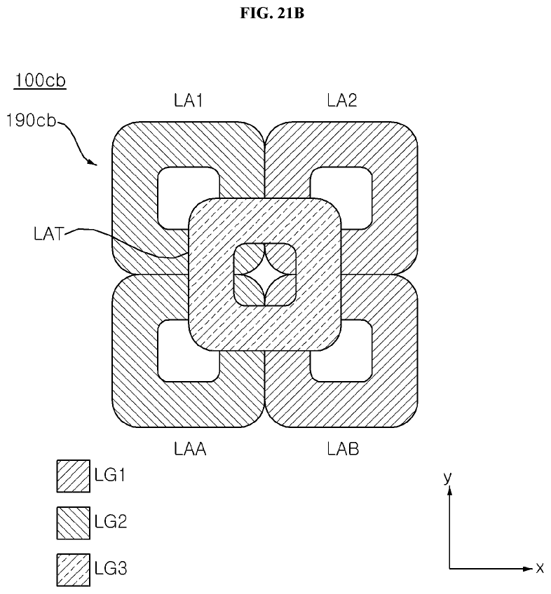

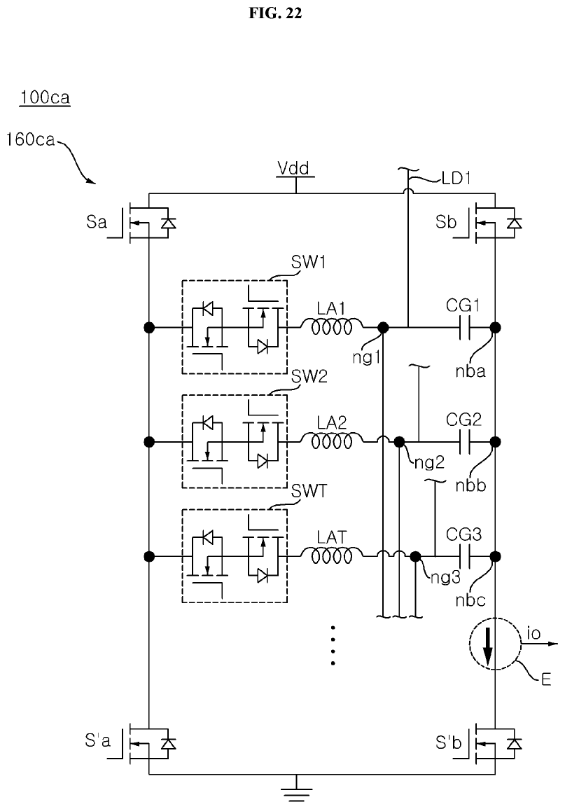

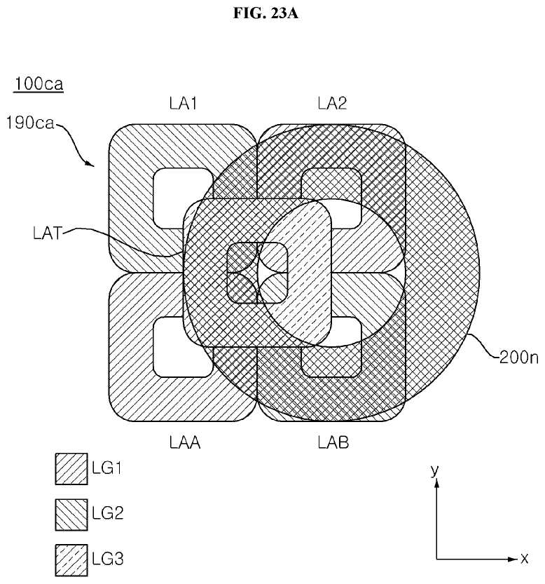

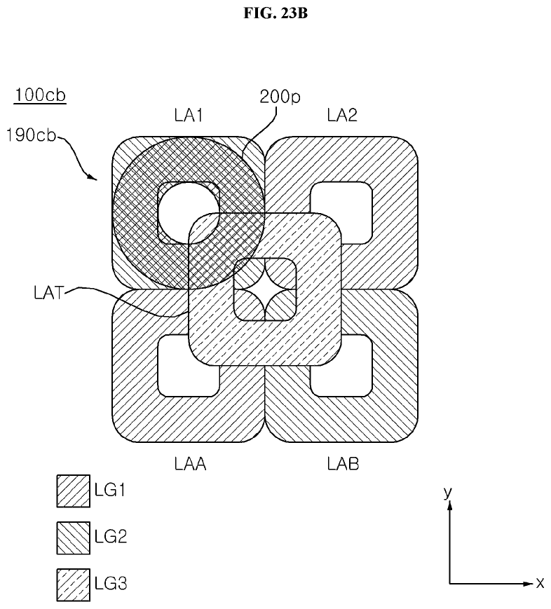

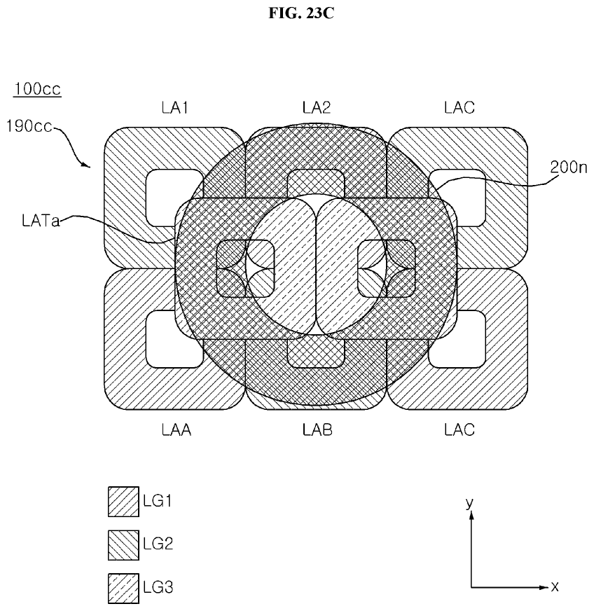

FIG. 19 is a circuit diagram illustrating an example of a wireless power transfer apparatus including a wireless power driver corresponding to FIG. 18A.

Referring to the drawing, a wireless power driver 160ba in the wireless power transfer apparatus 100ba according to an embodiment of the present disclosure may include a coil assembly 190ba including a plurality of coils LA1 to LAB, a first resonant capacitor CG1 connected to the first group LG1 among the plurality of coils LA1 to LAB, and a second resonant capacitor CG2 connected to the second group LG2 among the plurality of coils LA1 to LAB and connected in parallel to the first resonant capacitor CG1.

It is preferred that the number of groups of the plurality of coils LA1 to LAB is smaller than the number of the plurality of coils LA1 to LAB in the wireless power transfer apparatus 100 according to an embodiment of the present disclosure. Accordingly, it is possible to simply implement a circuit for selecting and operating at least some of the plurality of coils LA1 to LAB. Particularly, by using only the resonant capacitors CG1 and CG2 corresponding to the number of groups, the wireless power transfer apparatus 100ba may be reduced in size while simply implementing the circuit. In addition, a plurality of wireless power reception apparatuses 200 may be charged wirelessly by driving the plurality of coils.

For example, if the first coil LA1 in the first group LG1 and the second coil LA2 in the second group LG2 operate during a first period, a first current Ipath1m may flow to the first resonant capacitor CG1 based on turning on of the first coil switching device SW1, and a second current Ipath2m may flow to the second resonant capacitor CG2 based on turning on of the second coil switching device SW2.

In this case, during the first period, the controller 170 may receive first signal strength information through the first decoding line LD1 and second signal strength information through the second decoding line LD2.

Then, if the third coil LAA in the first group LG1 and the second coil LA2 in the second group LG2 operate during a second period, a third current Ipath3m may flow to the first resonant capacitor CG1 based on turning on of the third coil switching device SWA, and the second current Ipath2m may flow to the second resonant capacitor CG2 based on turning on of the second coil switching device SW2.

In this case, during the first period, the controller 170 may receive third signal strength information through the first decoding line LD1 and second signal strength information through the second decoding line LD2.

Next, if the third coil LAA in the first group LG1 and the fourth coil LAB in the second group LG2 operate during a third period, the third current Ipath3m may flow to the first resonant capacitor CG1 based on turning on of the third coil switching device SWA, and a fourth current Ipath4m may flow to the second resonant capacitor CG2 based on turning on of the fourth coil switching device SWB.

In this case, during the third period, the controller 170 may receive third signal strength information through the first decoding line LD1 and fourth signal strength information through the second decoding line LD2.

Based on the first to fourth pieces of signal strength information received during the first to third periods, the controller 170 may select at least one coil from among the plurality of coils LA1 to LAB and may drive the selected at least one coil.

Accordingly, a circuit for selecting and operating at least some of the plurality of coils LA1 to LAB may be simply implemented. In addition, a coil selection period may be significantly reduced, compared to the case of selecting coils by individually driving the plurality of coils LA1 to LAB.

FIGS. 20A to 20C are diagrams referred to in the description of operation of FIG. 19.

First, FIG. 20A is a diagram illustrating an example in which a wireless power reception apparatus 200m is located at a position corresponding to the first coil LA1 among the plurality of coils LA1 to LAB.

As illustrated in FIG. 19, the controller 170 receives the first to fourth pieces of signal strength information through the first decoding line LD1 and the second decoding line LD2 while driving two coils during the first to third periods.

Meanwhile, among the first to fourth pieces of signal strength information, if the first signal strength information is at a highest level and the third signal strength information is not received, the controller 170 may select and drive the first coil LA1.

Alternatively, if an in-band depth level of the first signal strength information is greater than an in-band depth level of the second signal strength information, the controller 170 may select and drive the first coil LA1.

Then, FIG. 20B is a diagram illustrating an example in which the wireless power reception apparatus 200m is located at a position corresponding to the first coil LA1 and the third coil LAA among the plurality of coils LA1 to LAB.

As illustrated in FIG. 19, the controller 170 receives the first to fourth pieces of signal strength information through the first decoding line LD1 and the second decoding line LD2 while individually driving two coils during the first to third periods.

Among the first to fourth pieces of signal strength information, if a level of the first signal strength information and a level of the third signal strength information are similar to each other and are greater than a level of the second signal strength information or a level of the fourth signal strength information, the controller 170 may select and drive the first coil LA1 and the third coil LAA.

Alternatively, if an in-band depth level of the first signal strength information is similar to an in-band depth level of the second signal strength information, the controller 170 may select and drive the first coil LA1 and the third coil LAA.

Then, FIG. 20C is a diagram illustrating an example in which the wireless power reception apparatus 200m is located at a position corresponding to the first coil LA1 among the plurality of coils LA1 to LAB.

As illustrated in FIG. 19, the controller 170 receives the first to fourth pieces of signal strength information through the first decoding line LD1 and the second decoding line LD2 while individually driving two coils during the first to third periods.

Further, among the first to fourth pieces of signal strength information, if the first signal strength information is at a highest level and is greater than a level of the second signal strength information and the like, the controller 170 may select and drive the first coil LA1.

Alternatively, if an in-band depth level of the first signal strength information is greater than an in-band depth level of the second signal strength information, the controller 170 may select and drive the first coil LA1.

As a result, after receiving the first to fourth pieces of signal strength information, the controller 170 may select a coil having an increasing in-band depth level, and may drive the selected coil.

FIGS. 21A and 21B are diagrams illustrating examples of a coil array divided into three groups.

First, FIG. 21A is a diagram illustrating a coil array 190ca including five coils LA1, LA2, LAA, LAB, and LAT.

The coil array 190ca of FIG. 21A is different from the coil array 190ba of FIG. 19A in that a coil LAT is further disposed in a central region, in addition to the coil array 190ba in 2×2 form of FIG. 19A.

According to the coil array 190ca in the wireless power transfer apparatus 100ca, the first coil LA1 and the second coil LAB adjacent to the first coil LA1 in a first direction (x-axis direction) and a second direction (y-axis direction or −y axis direction) may be included in the first group LG1 among the plurality of coils LA1 to LAT; the third coil LAA adjacent to the first coil LA1 in the second direction (y-axis direction or −y axis direction) and the fourth coil LA2 not adjacent to the third coil LAA in the first direction (x-axis direction) and the second direction (y-axis direction or −y axis direction) may be included in the second group LG2; and a fifth coil LAT may be included in a third group LG3. Accordingly, by grouping the coils not adjacent to each other, a wider area may be covered during wireless power transfer.

Next, FIG. 21B is a diagram illustrating a coil array 190cb including five coils LA1, LA2, LAA, LAB, and LAT.

The coil array 190cb of FIG. 21B is different from the coil array 190bb of FIG. 19B in that a coil LAT is further disposed in a central region, in addition to the coil array 190bb in 2×2 form of FIG. 19B.

According to the coil array 190cb in the wireless power transfer apparatus 100cb, the first coil LA1 and the third coil LAA adjacent to the first coil LA1 in the second direction (y-axis direction or −y axis direction) may be included in the first group LG1 among the plurality of coils LA1 to LAB; the second coil LA2 adjacent to the first coil LA1 in the first direction (x-axis direction) and the fourth coil LAB adjacent to the second coil LA2 in the second direction (y-axis direction or −y axis direction) may be included in the second group LG2; and a fifth coil LAT may be included in a third group LG3. Accordingly, by grouping the coils not adjacent to each other, a wider area may be covered during wireless power transfer.

FIG. 22 is a circuit diagram illustrating an example of a wireless power transfer apparatus including a wireless power driver corresponding to FIG. 21A.

Referring to the drawing, a wireless power driver 160ca in a wireless power transfer apparatus 100ca according to an embodiment of the present disclosure includes a coil assembly 190ca including a plurality of coils LA1 to LAT, a first resonant capacitor CG1 connected to the first group LG1 among the plurality of coils LA1 to LAT, a second resonant capacitor CG2 connected to the second group LG2 among the plurality of coils LA1 to LAT and connected in parallel to the first resonant capacitor CG1, and a third resonant capacitor CG3 connected to a third group LG3 among the plurality of coils LA1 to LAT and connected in parallel to the second resonant capacitor CG2.

It is preferred that the number of groups of the plurality of coils LA1 to LAT is smaller than the number of the plurality of coils LA1 to LAT in the wireless power transfer apparatus 100 according to an embodiment of the present disclosure. Accordingly, it is possible to simply implement a circuit for selecting and operating at least some of the plurality of coils LA1 to LAT. Particularly, by using only the resonant capacitors CG1, CG2, and CG3 corresponding to the number of groups, the wireless power transfer apparatus 100ca may be reduced in size while simply implementing the circuit. In addition, a plurality of wireless power reception apparatuses 200 may be charged wirelessly by driving the plurality of coils.

For example, if the first coil LA1 in the first group LG1, the second coil LA2 in the second group LG2, and the third coil LAT in the third group LG3 operate during a first period, a first current Ipathlm may flow to the first resonant capacitor CG1 based on turning on of the first coil switching device SW1, a second current may flow to the second resonant capacitor CG2 based on turning on of the second coil switching device SW2, and a third current may flow to the third resonant capacitor CG3 based on turning on of the third coil switching device SWT.

Accordingly, a circuit for selecting and operating at least some of the plurality of coils LA1 to LAT may be simply implemented. Particularly, coils may be simply driven by group.

FIGS. 23A to 23C are diagrams referred to in the description operation of FIG. 22.

First, FIG. 23A is a diagram illustrating an example in which a wireless power reception apparatus 200n of a second size is located at a position corresponding to the second coil LA2, the fourth coil LAB, and the fifth coil LAT in the coil assembly 190ca.

In this case, after receiving the signal strength information in response to driving of each of the plurality of coils, the controller 170 may operate the fourth coil LAB in the first group LG1, the second coil LA2 in the second group LG2, and the fifth coil LAT in the third group LG3.

Accordingly, the first to third currents respectively flow to the first to third resonant capacitors CG1 to CG3 of FIG. 22.

Next, FIG. 23B is a diagram illustrating an example in which a wireless power reception apparatus 200p of a first size, smaller than the second size, is located at a position corresponding to the first coil LA1 in the coil assembly 190cb.

In this case, after receiving the signal strength information in response to driving of each of the plurality of coils, the controller 170 may operate only the first coil LA1 in the first group LG1.

FIG. 23C is a diagram illustrating an example in which two coils LATa and LATb are further disposed in a central overlapping region, in addition to coils LA1, LA2, LA3, LAA, ALB, LAb, and LAC in 2×3 form.

Among the coils LA1, LA2, LA3, LAA, ALB, LAb, and LAC in 2×3 form, the coils LA1, LA3, ALB, and LA are included in the first group LG1, the coils LA2, LAA, and LAC are included in the second group LG2, and the two coils LATa and LATb in the overlapping region may be included in the third group LG3.

Meanwhile, in the drawing, an example is illustrated in which the wireless power reception apparatus 200n of the second size is located at a position corresponding to the second coil LA2, the fifth coil LAB, the seventh coil LATa, and the eighth coil LATb in the coil assembly 190ca.

In this case, after receiving the signal strength information in response to driving of each of the plurality of coils, the controller 170 may operate the fifth coil LATa in the first group LG1, the second coil LAT2 in the second group LG2, and the seventh coil LATa and the eighth coil LATb in the third group LGT.

Accordingly, similarly to FIG. 22, the first to third currents flow to the first to third resonant capacitors CG1 to CG3, respectively.

Meanwhile, the controller 170 in the wireless power transfer apparatus 100 according to another embodiment of the present disclosure may sequentially drive some coils in the first group LG1 and some coils in the second group LG2 among the plurality of coils LA1 to LAD, and based on signal strength information received from the wireless power reception apparatus 200 while the coils are sequentially driven, the controller 170 may select at least one coil and may operate the selected at least one coil.

Accordingly, it is possible to simply implement a circuit for selecting and operating at least some of the plurality of coils LA1 to LAD. Particularly, by using only the resonant capacitors corresponding to the number of groups, the wireless power transfer apparatus 100 may be reduced in size while simply implementing the circuit. In addition, a plurality of wireless power reception apparatuses 200 may be charged wirelessly by driving the plurality of coils.

Meanwhile, the controller 170 may receive signal strength information from the wireless power reception apparatus 200 in response to operation of some coils in the first group LG1 and operation of some coils in the second group LG2, may receive signal strength information from the wireless power reception apparatus 200 during the second period following the first period in response to operation of other coils in the first group LG1 and other coils in the second group LG2, and may operate at least one coil selected based on the signal strength information received during the first period and the second period. As described above, by selectively driving the coils by group, a coil selection period may be significantly reduced compared to the case of selecting coils by individually driving the plurality of coils LA1 to LAD.

Meanwhile, as illustrated in FIG. 10C, the controller 170 in the wireless power transfer apparatus 100 according to another embodiment of the present disclosure may receive the first signal strength information and the second signal strength information from the wireless power reception apparatus 200 through the first decoding line LD1 and the second decoding line LD2, respectively, and based on the first signal strength information or the second signal strength information, the controller 170 may select at least one coil from among the plurality of coils LA1 to LAD and operate the selected at least one coil. As described above, by selectively driving the coils by group, a coil selection period may be significantly reduced, compared to the case of selecting coils by individually driving the plurality of coils LA1 to LAD.

Meanwhile, the controller 170 in the wireless power transfer apparatus 100 according to yet another embodiment of the present disclosure may select at least one coil based on the signal strength information of each of the groups received from the wireless power reception apparatus 200 and may operate the selected at least one coil, and may change a group to be driven in response to movement of the wireless power reception apparatus 200. Accordingly, a circuit for selecting and operating at least some of the plurality of coils LA1 to LAD may be simply implemented. In addition, a group to be driven changes in response to movement of the wireless power reception apparatus 200 or in response to an increase in the number of wireless power reception apparatuses 200, such that adaptive wireless charging may be provided.

Meanwhile, if wireless power transfer at a level less than or equal to a first reference value is required, the controller 170 drives only one coil selected from the first group LG1 and the second group LG2, and if wireless power transfer at a level greater than the first reference value is required, the controller 170 drives two coils selected from the first group LG1 and the second group LG2 and greater in number than one coil. Accordingly, the number of operating coils may change depending on power required for wireless power transfer.

It will be apparent that, although the preferred embodiments have been shown and described above, the present disclosure is not limited to the above-described specific embodiments, and various modifications and variations can be made by those skilled in the art without departing from the gist of the appended claims. Thus, it is intended that the modifications and variations should not be understood independently of the technical spirit or prospect of the present disclosure.

1. A wireless power transfer apparatus comprising:
a coil assembly including a plurality of coils;
a first resonant capacitor connected to a first group among the plurality of coils; and
a second resonant capacitor connected to a second group among the plurality of coils, and connected in parallel to the first resonance capacitor,
wherein a number of the groups of the plurality of coils are less than a number of the plurality of coils.

2. The wireless power transfer apparatus of claim 1, wherein the first group includes a first coil among the plurality of coils and a coil not adjacent to the first coil, and the second group includes a second coil adjacent to the first coil and a coil not adjacent to the second coil.

3. The wireless power transfer apparatus of claim 1, further comprising a plurality of coil switching devices respectively connected to the plurality of coils,
wherein, based on simultaneous turning on of one or more coil switching devices respectively connected to some of the plurality of coils in the first group and one or more coil switching devices respectively connected to some of the plurality of coils in the second group, a first current flows to the first resonant capacitor, and a second current flows to the second resonant capacitor.

4. The wireless power transfer apparatus of claim 1, further comprising:
an inverter configured to perform a switching operation to supply power to at least one of the plurality of coils; and
a controller configured to control the inverter,
wherein the controller is configured to:
during a first period, receive first signal strength information and second signal strength information from a wireless power reception apparatus in response to operation of some coils in the first group and some coils in the second group among the plurality of coils;
during a second period following the first period, receive third signal strength information from the wireless power reception apparatus in response to operation of other coils in the first group and other coils in the second group among the plurality of coils; and
based on the first to third pieces of signal strength information, select at least one coil from among the plurality of coils and operate the selected coil.

5. The wireless power transfer apparatus of claim 3, further comprising:
a plurality of coil switching devices respectively connected to the plurality of coils;
an inverter configured to perform a switching operation to supply power to at least one of the plurality of coils; and
a controller configured to control the inverter,
wherein the controller is configured to:
during a first period, receive first signal strength information and second signal strength information from a wireless power reception apparatus in response to turning on one or more coil switching devices respectively connected to some coils in the first group and one or more coil switching devices respectively connected to some coils in the second group among the plurality of coils;
during a second period following the first period, receive third signal strength information from the wireless power reception apparatus in response to turning on one or more coil switching devices respectively connected to other coils in the first group and one or more coil switching devices respectively connected to other coils in the second group among the plurality of coils; and
based on the first to third pieces of signal strength information, select at least one coil from among the plurality of coils and operate the selected coil.

6. The wireless power transfer apparatus of claim 1, further comprising:
a first decoding line connected to the first resonant capacitor;
a second decoding line connected to the second resonant capacitor;
an inverter configured to perform a switching operation to supply power to at least one of the plurality of coils; and
a controller configured to control the inverter,
wherein the controller is configured to:
receive first signal strength information and second signal strength information from the wireless power reception apparatus through the first decoding line and the second decoding line, respectively; and
based on the first to third pieces of signal strength information, select at least one coil from among the plurality of coils and operate the selected coil.

7. The wireless power transfer apparatus of claim 6, wherein the controller is configured to:
during a first period, receive first signal strength information and second signal strength information from the wireless power reception apparatus through the first decoding line and the second decoding line, in response to operation of some coils in the first group and some coils in the second group among the plurality of coils;
during a second period following the first period, receive third signal strength information and fourth signal strength information from the wireless power reception apparatus through the first decoding line and the second decoding line, in response to operation of other coils in the first group and other coils in the second group among the plurality of coils; and
based on the first to fourth pieces of signal strength information, select at least one coil from among the plurality of coils and operate the selected coil.

8. The wireless power transfer apparatus of claim 1, wherein:
the first group includes a first coil among the plurality of coils and a second coil adjacent to the first coil in a first direction, and
the second group includes a third coil adjacent to the first coil in a second direction and a fourth coil adjacent to the third coil in the first direction.

9. The wireless power transfer apparatus of claim 1, wherein in response to the plurality of coils being arranged in the first direction, the first group includes the first coil and the third coil among the first to fourth coils, and the second group includes the second coil and the fourth coils among the plurality of coils.

10. The wireless power transfer apparatus of claim 1, further comprising:
a third resonant capacitor connected to a third group among the plurality of coils;
a switching inverter configured to perform a switching operation to supply power to at least one of the plurality of coils; and
a controller configured to control the inverter,
wherein the controller is configured to:
during a first period, receive signal strength information from the wireless power reception apparatus in response to operation of some coils in the first group, some coils in the second group, and some coils in the third group among the plurality of coils; and
based on the signal strength information received during the first period, select at least one coil from among the plurality of coils and operate the selected coil.

11. The wireless power transfer apparatus of claim 10, wherein the controller is configured to:
during a second period following the first period, receive signal strength information from the wireless power reception apparatus in response to operation of other coils in the first group and other coils in the second group; and
based on the signal strength information received during the first period and the second period, select at least one coil from among the plurality of coils and operate the selected coil.

12. The wireless power transfer apparatus of claim 1, further comprising:
a plurality of coil switching devices respectively connected to the plurality of coils;
an inverter configured to perform a switching operation to supply power to at least one of the plurality of coils; and
a controller configured to control the inverter,
wherein the controller is configured to:
in response to wireless power transfer at a level less than or equal to a first reference value being required, drive only one coil selected from among the first group and the second group; and
in response to wireless power transfer at a level greater than the first reference value being required, drive two coils selected from among the first group and the second group and greater in number than the one coil.

13. The wireless power transfer apparatus of claim 1, further comprising:
a plurality of coil switching devices respectively connected to the plurality of coils;
an inverter configured to perform a switching operation to supply power to at least one of the plurality of coils; and
a controller configured to control the inverter,
wherein the controller is configured to:
in response to the wireless power transfer apparatus being spaced apart from the wireless power reception apparatus by a first distance, drive only one coil selected from among the first group and the second group; and
in response to the wireless power transfer apparatus being spaced apart from the wireless power reception apparatus by a second distance which is larger than the first distance, drive two coils selected from among the first group and the second group and greater in number than the one coil.

14. The wireless power transfer apparatus of claim 1, further comprising:
a plurality of coil switching devices respectively connected to the plurality of coils;
an inverter configured to perform a switching operation to supply power to at least one of the plurality of coils; and
a controller configured to control the inverter,
wherein the controller is configured to:
in response to movement of the wireless power reception apparatus while at least some coils in the first group are driven, operate the at least some coils in the first group and at least some coils in the second group.

15. A wireless power transfer apparatus comprising:
a coil assembly including a plurality of coils;
a first resonant capacitor connected to a first group among the plurality of coils;
a second resonant capacitor connected to a second group among the plurality of coils,
an inverter configured to perform a switching operation to supply power to at least one of the plurality of coils; and
a controller configured to control the inverter,
wherein the controller is configured to sequentially drive some coils in the first group and some coils in the second group, and to select at least one coil based on signal strength information, received from a wireless power reception apparatus while sequentially driving the coils, and operate the selected at least one coil.

16. The wireless power transfer apparatus of claim 15, wherein the controller is configured to:
during a first period, receive signal strength information from the wireless power reception apparatus in response to operation of some coils in the first group and some coils in the second group;
during a second period following the first period, receive signal strength information from the wireless power reception apparatus in response to operation of other coils in the first group and other coils in the second group; and
operate at least one coil selected based on the signal strength information received during the first period and the second period.

17. The wireless power transfer apparatus of claim 15, further comprising:
a first decoding line connected to the first resonant capacitor; and
a second decoding line connected to the second resonant capacitor;
wherein the controller is configured to:
receive first signal strength information and second signal strength information from the wireless power reception apparatus through the first decoding line and the second decoding line, respectively; and
based on the first to third pieces of signal strength information, select at least one coil from among the plurality of coils and operate the selected at least one coil.

18. A wireless power transfer apparatus comprising:
a coil assembly including a plurality of coils;
in response to the plurality of coils being divided into a plurality of groups, a plurality of resonant capacitors connected corresponding to the plurality of groups;
an inverter configured to perform a switching operation to supply power to at least one of the plurality of coils; and
a controller configured to control the inverter,
wherein the controller is configured to:
based on signal strength information received from the wireless power reception apparatus for each of the plurality of groups, operate at least some coils among the plurality of coils; and
in response to movement of the wireless power reception apparatus, change coils to be driven.

19. The wireless power transfer apparatus of claim 18, wherein the controller is configured to:
in response to wireless power transfer at a level less than or equal to a first reference value being required, drive only one coil selected from among the first group and the second group; and
in response to wireless power transfer at a level greater than the first reference value being required, drive two coils selected from among the first group and the second group and greater in number than the one coil.

20. A wireless power system comprising:
a wireless power reception apparatus; and
a wireless power transfer apparatus;
wherein the wireless power transfer apparatus comprises:
a coil assembly including a plurality of coils;
a first resonant capacitor connected to a first group among the plurality of coils; and
a second resonant capacitor connected to a second group among the plurality of coils, and connected in parallel to the first resonance capacitor,
wherein a number of the groups of the plurality of coils are less than a number of the plurality of coils.
